(19) United States
(12) Patent Application Publication
(10) Pub. No.: US 2024/0334582 A1
(43) Pub. Date: Oct. 3, 2024

(54) APPARATUS AND METHODS FOR GENERATING TUNABLE X-RAYS VIA THE INTERACTION OF FREE ELECTRONS WITH PERIODIC STRUCTURES

(71) Applicant: NANYANG TECHNOLOGICAL UNIVERSITY, Singapore (SG)

(72) Inventors: Liang Jie WONG, Singapore (SG); Sunchao HUANG, Singapore (SG); Christopher Brian BOOTHROYD, Singapore (SG)

(73) Assignee: NANYANG TECHNOLOGICAL UNIVERSITY, Singapore (SG)

(21) Appl. No.: 18/580,080

(22) PCT Filed: Aug. 23, 2022
(86) PCT No.: PCT/SG2022/095003

§ 371 Date: Jan. 17, 2024

(30) Foreign Application Priority Data
Aug. 23, 2021 (SG) 10202109188Y

(51) Int. Cl. H05G 1/30; H01J 35/08; H01J 35/18

(52) U.S. Cl. CPC H05G 1/30; H01J 35/112; H01J 35/18; H01J 2235/086; H01J 2235/088

(57) ABSTRACT

A method of generating X-ray emission, and a system for generating X-ray emission are provided. The method comprises the steps of generating a beam of free electrons using an electron source; directing the beam of free electrons onto a crystalline material having a periodic material structure; generating X-ray emission as a result of the interaction between the free electrons and the crystalline material; and extracting a portion of the X-ray emission for providing an X-ray beam having a selected photon energy; wherein the selected photon energy is tunable by controlling, at least, a tilt angle of the crystalline material relative to the beam of free electrons.

### FIELD OF INVENTION

The present invention relates broadly to apparatus and methods for generating tunable x-rays via the interaction of free electrons with periodic structures.

### BACKGROUND

Any mention and/or discussion of prior art throughout the specification should not be considered, in any way, as an admission that this prior art is well known or forms part of common general knowledge in the field.

X-rays—discovered by Wilhelm Conrad Röntgen in 1895—have many important applications in daily life, academic research, and industry due to their ability to penetrate materials. To give a few examples, X-rays are used in medical imaging and diagnosis; X-rays are used for security scanning in airports; X-rays are used to probe crystal structures and crystal orientation in fundamental research; and X-rays are used to perform non-destructive inspection in the manufacturing process.

Currently, X-ray tubes are the most popular X-ray sources due to their small size and affordable prices. The working principle of X-ray tubes is based on the interaction between free electrons and target materials, where free electrons with kinetic energy on the order of a hundred keV hit the target and produce X-rays via a continuous Bremsstrahlung radiation spectrum and discrete characteristic radiation peaks. The photon energy of characteristic radiation is fixed by the choice of the target materials. Therefore, the frequencies of the X-ray peaks are not tunable for a given anode material. Additionally, the X-rays are emitted in all directions, leading to power wastage in the directions where the X-rays are not used. Furthermore, the X-rays are incoherent, making them challenging for use in applications that require coherent photons.

Tunable and directional X-rays are available in synchrotrons and free electron lasers, which are produced by GeV free electrons. Obtaining GeV free electrons requires huge acceleration facilities in kilometre size and carefully designed radiation shielding, which limits their use on a widespread scale.

In free electron radiation, the emitted beam is concentrated into a forward cone with half angle around 1/γ radians. Here γ is the Lorentz factor, which is around 1 for 100 keV electron and 2000 for 1 GeV electron. In X-ray tubes, the electron energy is on the order of 100 keV, while it is on the order of GeV in Synchrotron and free electron lasers. Thus, synchrotron and free electron lasers produce more directional radiation than X-ray tubes.

Embodiments of the present invention seek to address at least one of the above problems.

### SUMMARY

In accordance with a first aspect of the present invention, there is provided a method of generating X-ray emission, comprising the steps of:
generating a beam of free electrons using an electron source;
directing the beam of free electrons onto a crystalline material having a periodic material structure;
generating X-ray emission as a result of the interaction between the free electrons and the crystalline material; and
extracting a portion of the X-ray emission for providing an X-ray beam having a selected photon energy;
wherein the selected photon energy is tunable by controlling, at least, a tilt angle of the crystalline material relative to the beam of free electrons.

In accordance with a second aspect of the present invention, there is provided a system for generating X-ray emission, comprising:
an electron source disposed in a vacuum chamber for generating a beam of free electrons;
an electron optics disposed in the vacuum chamber for directing the beam of free electrons onto a crystalline material disposed in the vacuum chamber and having a periodic material structure, whereby X-ray emission is generated as a result of the interaction between the free electrons and the crystalline material; and
one or more windows in a wall structure of the vacuum chamber for extracting a portion of the X-ray emission for providing an X-ray beam having a selected photon energy, the one or more windows having respective selected dimensions and collection angles at respective selected distances from the crystalline material such that only the X-ray beams passing through the respective one or more windows are extracted while a remaining portion of the generated X-ray emission is blocked;
wherein the selected photon energy is tunable by controlling, at least, a tilt angle of the crystalline material relative to the beam of free electrons.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1A shows a schematic drawing of a device that generates highly tunable X-rays from the interaction of free electrons with periodic structures, according to an example embodiment.

FIG. 1B shows a schematic drawing visualizing how to continuously change the port (or window) position and port size of a device that generates highly tunable X-rays from the interaction of free electrons with periodic structures, according to an example embodiment.

FIG. 1C shows a schematic drawing visualizing how to continuously change the port (or window) position and port size of a device that generates highly tunable X-rays from the interaction of free electrons with periodic structures, according to another example embodiment.

FIG. 2 shows a schematic drawing visualizing how a detector and sample attached to one window can have freedom of motion in swivelling potentially up to 360 degrees about the X-ray source, according to an example embodiment. The distance between the X-ray source and X-ray detector can be changed.

FIG. 3 shows the collection angle dependence of the emitted X-ray photon energy according to an example embodiment, where the periodic structure is vdW single crystal WSe₂ and the kinetic energy of the incident electrons is 100 keV at different emission orders.

FIG. 4 shows that the energy of collected X-ray photons is tunable via the periodic structure design according to an example embodiment, i.e., changing the periodicity of the periodic structure d, at different emission orders.

FIG. 5 shows that, keeping all other conditions unchanged, the collected X-ray photon energy is tunable via electron kinetic energy at different emission orders, according to an example embodiment.

FIG. 6 shows that the collected X-ray photon energy is also tunable via the periodic structure tilt according to an example embodiment at different emission orders, where the periodic structure is vdW single crystal WSe₂.

FIG. 7 shows a tunable X-ray source according to an example embodiment, generated by the interaction of SEM free electrons with graphite single crystal.

FIG. 8 shows the tunability of X-ray radiation via varying the tilt angle of the periodic structure, according to an example embodiment.

FIG. 9A shows photon energy tunability is achieved by tuning the incident electron energy, according to an example embodiment.

FIG. 9B shows that enhanced photon energy tunability is achieved by simultaneously tuning both incident electron energy and WSe₂ single crystal tilt angle, according to an example embodiment.

FIG. 10 shows a schematic drawing of a tunable X-ray source according to an example embodiment, generated by the interaction of free electrons with a periodic material in Smith-Purcell configuration.

FIG. 11A shows a schematic drawing of a tunable X-ray source according to an example embodiment, generated by free electrons that penetrate through a hole of periodic material.

FIG. 11B shows a schematic drawing of a bird's eye view of the periodic material of the tunable X-ray source of FIG. 11A.

FIG. 12 shows a schematic drawing of a tunable X-ray source according to an example embodiment, generated by the interaction of free electrons with a periodic material in channeling configuration.

FIG. 13 shows a schematic drawing of a tunable X-ray source according to an example embodiment, generated by free electrons that pass through a nanotube.

FIG. 14 shows a schematic drawing of a tunable multi-colour X-ray source according to an example embodiment generated by the interaction of free electrons with multi-layer vdW structure.

FIG. 15 shows a schematic drawing of a scenario where the frequency peak and other characteristics of the X-ray source according to an example embodiment can be controlled by applying mechanical stress, strain, pressure, bending or any kind of deformation to the target material in real-time, by applying force at one or more points of the target material.

FIG. 16 shows a schematic drawing of an X-ray device according to an example embodiment providing highly tunable X-ray sources for computed tomography (CT) scan.

FIG. 17 shows a schematic drawing of an X-ray device according to an example embodiment providing highly tunable X-ray sources for hyperspectral X-ray imaging.

FIG. 18A shows a schematic drawing of incident an electron beam scattering off the periodic lattice of a vdW material, generating X-rays via parametric X-ray radiation and coherent Bremsstrahlung, according to an example embodiment.

FIG. 18B shows a spectra generated by a 200 keV electron beam impinging on a WSe₂ single crystal (left top insert shows its TEM image) at various tilt angles θₜᵢₗ, defined as the angle between the incident electron beam and the [001] zone axis, according to an example embodiment.

FIG. 18C shows photon energy tunability is achieved by varying the electron energy, according to an example embodiment.

FIG. 18D shows enhanced photon energy tunability is achieved by simultaneously varying both the electron energy and the vdW structure tilt angle, according to an example embodiment.

FIG. 18E shows a schematic drawing of tunability of X-ray emission from van der Waals (vdW) materials by varying the crystal tilt angle, according to an example embodiment.

FIG. 18F shows intensity spectra generated by a 200 keV electron beam interacting with a WSe₂ single crystal at various tilt angles, according to an example embodiment.

FIG. 18G shows the TEM image of WSe₂ single crystal, used to generate the X-ray emission according to an example embodiment.

FIG. 18H shows Kikuchi pattern used to calibrate the tilt angle within 0.5 degrees of accuracy, according to an example embodiment.

FIG. 19A shows brightness as a function of electron energy for θₜᵢₗ from 0° to 80° in WSe₂ crystal, where [b.u.] (“brightness units”) stands for [photons s⁻¹ mm⁻² mrad⁻² per 0.1% BW], according to an example embodiment.

FIG. 19B shows accessible photon energy range by tuning along the arrows in the colormap in FIG. 19A, according to an example embodiment.

FIG. 20A shows the experimental setup where free electrons in the scanning electron microscope (SEM) impinge on the layered van der Waals single crystal, resulting in X-ray emission via parametric X-ray generation (PXR), according to an example embodiment.

FIG. 20B shows that in the classical model of PXR, the electron momentum is assumed unchanged throughout the interaction.

FIG. 20C shows that the quantum model takes electron recoil into account, resulting in a deflected outgoing electron and shifted outgoing photon energies.

FIG. 21A shows the X-ray spectrum generated by a 12 keV electron beam incident on the (001) lattice planes of a graphite crystal of thickness about 100 nm, according to an example embodiment.

FIG. 21B shows the difference 2E₂-E₄ is always zero in the classical model, independent of electron energy and tilt angle of the graphite crystal, however, this value is finite in the quantum model.

FIG. 22A illustrates the bremsstrahlung process involving shaped input electrons scattering off a graphene flake (lying in xy-plane) into output photons and electrons, according to an example embodiment.

FIG. 22B shows (i) the electron population density distribution Ψᵢ^{†}Ψᵢ in space (atom locations denoted by circles) and (ii) the coherent differential cross section dσ/dωₖdΩₖ of bremsstrahlung emission, respectively, for certain Nₛ and Nₐ.

FIG. 22C shows (i) the electron population density distribution Ψᵢ^{†}Ψᵢ in space (atom locations denoted by circles) and (ii) the coherent differential cross section dσ/dωₖdΩₖ of bremsstrahlung emission, respectively, for certain Nₛ and Nₐ.

FIG. 22D shows (i) the electron population density distribution Ψᵢ^{†}Ψᵢ in space (atom locations denoted by circles) and (ii) the coherent differential cross section dσ/dωₖdΩₖ of bremsstrahlung emission, respectively, for certain Nₛ and Nₐ.

FIG. 22E shows (i) the electron population density distribution Ψᵢ^{†}Ψᵢ in space (atom locations denoted by circles) and (ii) the coherent differential cross section dσ/dωₖdΩₖ of bremsstrahlung emission, respectively, for certain Nₛ and Nₐ.

FIG. 23A shows enhancing bremsstrahlung emission via electron waveshaping: comparing the actual (coherent) differential cross section with its incoherent counterpart as a function of Nₐ and Nₛ, according to an example embodiment.

FIG. 23B shows enhancing bremsstrahlung emission via electron waveshaping: comparing the actual (coherent) differential cross section with its incoherent counterpart as a function of Nₐ and Nₛ, according to an example embodiment.

FIG. 24A shows a schematic drawing of a free electron beam impinging on a vdW heterostructure, generating multicolor X-rays via parametric X-ray radiation (PXR) and coherent Bremsstrahlung (CB), according to an example embodiment.

FIG. 24B shows a light microscope image of MoS₂/graphite heterostructure on a silicon substrate coated with 285 nm SiO₂ film, for use in an example embodiment.

FIG. 24C shows a scanning electron microscopy (SEM) image of the heterostructure on a transmission electron microscopy (TEM) grid, for use in an example embodiment.

FIG. 24D shows an TEM image of the portion of FIG. 24C where the multicolor X-rays is generated with incident free electrons, according to an example embodiment.

FIG. 24E shows the multicolor X-ray spectra generated by a free electron beam impinging on the MoS₂/graphite heterostructure, according to an example embodiment.

FIG. 25A shows the tunability of the output photon energies by tilting the entire heterostructure relative to the electron beam direction, according to an example embodiment.

FIG. 25B shows that the relative intensity of the X-ray peaks can be tailored by varying the position where the electron beam impinges on the heterostructure, according to an example embodiment.

FIG. 25C shows a schematic drawing illustrating that when the electron beam mainly interacts with the pure graphite layer, a strong X-ray peak from graphite is measured, according to an example embodiment.

FIG. 25D shows a schematic drawing illustrating that when the electron beam partly interacts with the pure graphite and partly with the MoS₂/graphite heterostructure, a strong (weak) X-ray peak from graphite (MoS₂) is measured, according to an example embodiment.

FIG. 25E shows a schematic drawing illustrating that when the electron interacts with the MoS₂/graphite heterostructure and moves away from the heterostructure region towards pure MoS₂, one obtains a strong X-ray peak from MoS₂ and a weak X-ray peak from graphite, according to an example embodiment.

FIG. 26A shows the output X-ray photon energies from various vdW materials at three values of incident electron energies where the θₜᵢₗⁿ=0°, according to example embodiments.

FIG. 26B shows the tunability of the output X-ray photon energies generated from a vdW heterostructure comprising HfS₂, Graphite, GeSe and MoS₂ (the inset) by varying the electron kinetic energy, according to example embodiments.

FIG. 26C show the tunability of the output X-ray photon energies generated from a vdW heterostructure comprising HfS₂, Graphite, GeSe and MoS₂ by varying the tilt angle of the heterostructure relative to the electron beam, according to example embodiments.

FIG. 26D shows the calculated radiation intensity from the heterostructure, where the thickness of HfS₂, graphite, GeSe and MoS₂ is 100 nm, 100 nm, 30 nm, and 15 nm, respectively, according to example embodiments.

FIG. 27A shows brightness colormap plotted as a function of emitted photon energy and the observation angle θ_{obs} for 100 keV electron beam, according to an example embodiment.

FIG. 27B shows the brightness spectrum observed at 130° observation angle corresponding to FIG. 27A.

FIG. 27C shows brightness colormap plotted as a function of emitted photon energy and the observation angle θ_{obs} for 300 keV electron beam, according to an example embodiment.

FIG. 27D shows the brightness spectrum observed at 130° observation angle corresponding to FIG. 27C.

FIG. 27E shows brightness colormap plotted as a function of emitted photon energy and the observation angle θ_{obs} for 1000 keV electron beam, according to an example embodiment.

FIG. 27F shows the brightness spectrum observed at 130° observation angle corresponding to FIG. 27E.

FIG. 28A shows X-ray spectra from WS₂ at 120 keV, according to an example embodiment.

FIG. 28B shows X-ray spectra from WS₂ at 200 keV, according to an example embodiment.

FIG. 28C shows X-ray spectra from MoSe₂ at 120 keV, according to an example embodiment.

FIG. 28D shows X-ray spectra from MoSe₂ at 200 keV, according to an example embodiment.

FIG. 28E shows X-ray spectra from MoS₂ at 80 keV, according to an example embodiment.

FIG. 28F shows X-ray spectra from MoS₂ at 300 keV, according to an example embodiment.

FIG. 29A shows the accessible photon energy range, and the percentage enhancement in the photon energy range, according to example embodiments.

FIG. 29B shows the calculated photon brightness as a function of electron energy for θₜᵢₗ from 0° to 80° at a certain θ_{obs}, according to an example embodiment.

FIG. 29C shows the calculated photon brightness as a function of electron energy for θₜᵢₗ from 0° to 80° at a certain θ_{obs}, according to an example embodiment.

FIG. 29D shows the accessible photon energy range by tuning along the arrow in colormap FIG. 29B.

FIG. 29E shows the accessible photon energy range by tuning along the arrow in colormap FIG. 29C.

FIG. 30A shows a schematic drawing illustrating that in the classical model, the Coulomb field of an electron scatters off the sub-nanometer grating furnished by the (00m̅) atomic planes of a crystal (in this case, the vdW crystal graphite), resulting in the emission of a photon without any change in the electron's energy and momentum.

FIG. 30B shows a schematic drawing illustrating that energy and momentum conservation, however, requires electron deceleration, resulting in a shift in the output photon energy ℏΔωᵢ (relative to the classically predicted value of ℏω in FIG. 30A).

FIG. 30C shows experimental measurements and theoretical predictions of the X-ray output, with ω₂ and ω₄ being the peaks corresponding to the (002̅) and ((004̅)) reciprocal lattice vectors of graphite respectively.

FIG. 30D shows the difference 2ℏω₂−ℏω₄, which should be 0 in the absence of recoil and finite in the presence of recoil.

FIG. 31A shows quantum recoil-induced photon energy shifts in spontaneous emission from free electrons interacting with graphite for 11 keV, according to example embodiments.

FIG. 31B shows quantum recoil-induced photon energy shifts in spontaneous emission from free electrons interacting with graphite for 12 keV, according to example embodiments.

FIG. 31C shows quantum recoil-induced photon energy shifts in spontaneous emission from free electrons interacting with graphite for 13 keV, according to example embodiments.

FIG. 31D shows quantum recoil-induced photon energy shifts in spontaneous emission from free electrons interacting with hexagonal boron nitride (h-BN) for 11 keV, according to example embodiments.

FIG. 31E shows quantum recoil-induced photon energy shifts in spontaneous emission from free electrons interacting with hexagonal boron nitride (h-BN) for 11.5 keV, according to example embodiments.

FIG. 31F shows quantum recoil-induced photon energy shifts in spontaneous emission from free electrons interacting with hexagonal boron nitride (h-BN) for 12 keV, according to example embodiments.

FIG. 32 shows tuning quantum recoil-induced photon energy shifts in parametric X-ray radiation, according to example embodiments.

FIG. 33 shows a flowchart illustrating a method of generating X-ray emission, according to an example embodiment.

### DETAILED DESCRIPTION

Embodiments of the present invention can provide a smoothly tunable, highly directional and potentially coherent X-ray source that can be put on a tabletop or put into a normal size lab. Tunable X-ray sources according to example embodiments emit X-ray photons by the interaction of free electrons with periodic structures (materials). The periodic structures used in example embodiments can be various single crystals, quasi-single crystals, and artificial materials such as metamaterials, photonic crystals, and so on. The frequency of the emitted photons is highly tunable via the kinetic energy of the incident electrons and the angle (θ_{g}) between the incident electrons and the periodic structure. The frequency also depends on the observation angle θ_{obs}, which is the angle between the electron beam and the collection direction.

In one example embodiment, a tunable X-ray source based on the interaction of scanning free electrons from an electron source with two-dimensional van der Waals (vdW) single crystals is provided. It is theoretically predicted and experimentally demonstrated that more than double the photon energy range is achievable through dynamic tuning of the X-ray source according to an example embodiment. The tunability can be optimized by simultaneously controlling both electron energy and vdW crystal tilt, in an example embodiment.

In one of the example embodiments, an X-ray source based on the interaction of free electrons with vdW heterostructures that can generate multi-colour X-rays (multi X-ray peaks). The colour (frequency) of each X-rays is highly tunable via the kinetic energy of the incident electrons or the angle θ_{g}. Moreover, the relative intensity of the X-ray peaks is also tunable.

As discussed in the background section, the most popular X-ray tubes to-date that are small enough for daily usage have the problem that their X-ray frequency is neither tunable nor directional. On the other hand, synchrotron and free electron laser X-ray sources are tunable and powerful, however, their widespread usage is severely hindered by their large size and high costs. Embodiments of the present invention provide an alternative X-ray source design, one that is small enough to put on a desktop or normal size lab, and the frequency of X-ray source is highly tunable.

### Highly Tunable X-Ray Sources Based on Parametric X-Ray Radiation (PXR) According to an Example Embodiment

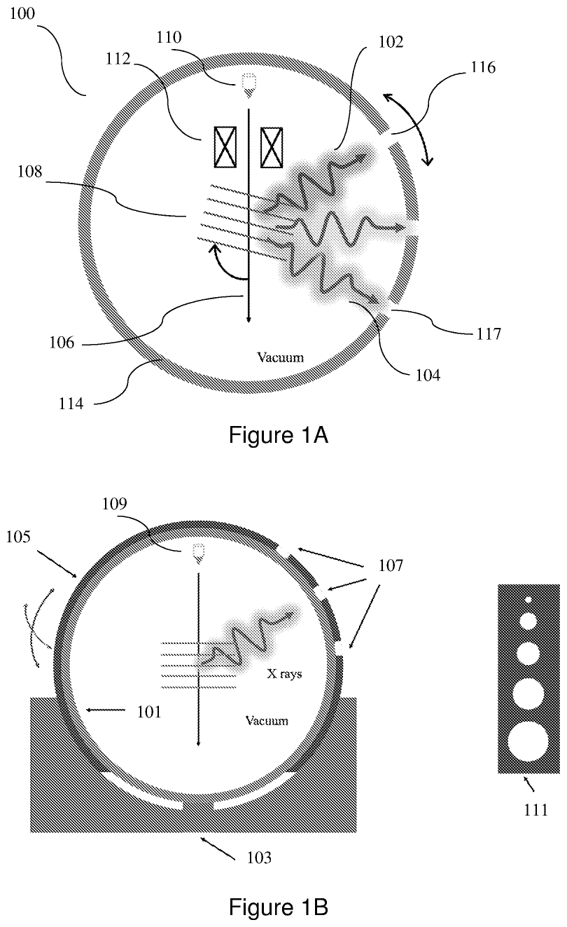

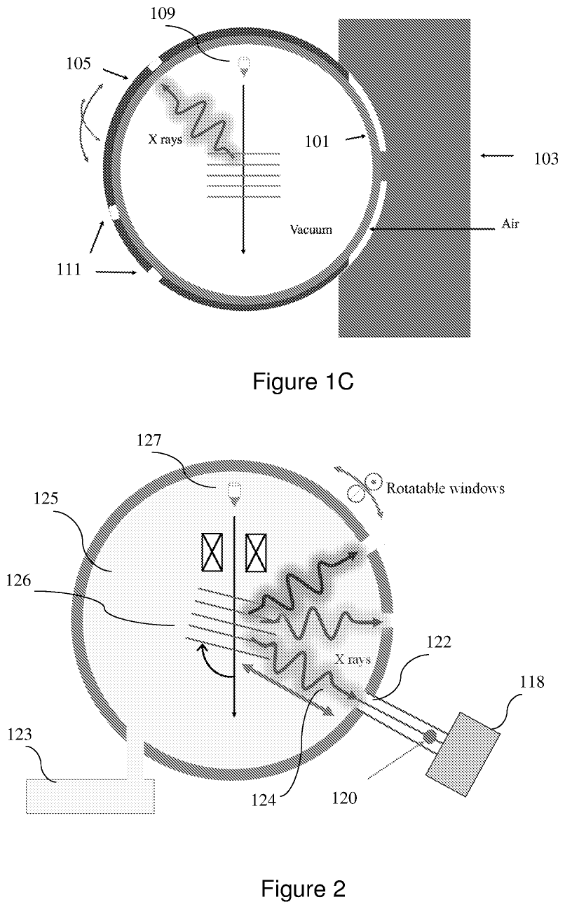

FIG. 1A shows a device 100 according to an example embodiment that generates highly tunable X-rays e.g., 102, 104 from the interaction of free electrons 106 with periodic structures 108. The electron source 110 provides relatively low-energy free electrons 106 from 1 keV to 500 keV. However, it is noted that the device also can work in lower and higher electron energy in different embodiments. These electrons 106 are shaped by the electron beam shaping element 112 (e.g., focus lens) and then interact with the periodic structures 108. To reduce the intensity of continuous Bremsstrahlung radiation, the optimal thickness of the periodic structure 108 is about a few hundred nanometres. The device 100 is implemented with a vacuum chamber 114 to provide vacuum to reduce collision between electrons 106 and gas. The vacuum chamber 114 provides, or is provided with, a shield (e.g., a perfect sphere, although any other geometry can be used) to stop X-ray hazards. The periodic structure 108 is located inside the vacuum chamber 114, typically, but not limited to, at the centre.

There are one or more circular X-ray windows (or ports) e.g. 116 (can also be of other shape, but they are treated as circular for the calculations/simulations/experiments described herein) in the wall of the vacuum chamber 114 that let X-rays pass through. The windows e.g. 116 are rotatable both in polar angle and azimuthal angle.

With reference to FIGS. 1B and 1C, an X-ray transparent inner shell (made of materials such as polymer and/or Beryllium) 101 is employed to maintain a vacuum environment, which is supported a foundation bed 103. The outer partial shell 105 (impenetrable to X-rays, e.g., using lead as a material) is concentric to the inner shell 101, and the outer partial shell 105 is rotatable both in polar angle and azimuthal angle. On the outer partial shell 105, there are many X-ray transparent windows (or ports) 107. The configuration can be adjusted to access different X-ray emission angles, for example by changing the orientation of the foundation bed 103 relative to the electron source 109, compare FIGS. 1B and 1C.

This enables a smooth change in the collection angle. Additionally, the radius of the circular X-ray windows 107 is adjustable, which enables controlling the full width at half maximum (FWHM) of the collected X-ray spectrum. The window size can be adjusted by changing the aperture 111 size that is attached on the windows 107.

With reference again to FIG. 1A, the energy of collected X-rays e.g. 102, 104 at different windows e.g. 116, 117 has different frequencies due to the Doppler effect. FIG. 2 visualizes how a detector 118 (e.g. imaging plane, spectroscope, CCD camera etc.) and sample 120 attached to one window 122 can have freedom of motion in swivelling potentially up to 360 degrees relative to the X-ray source, specifically the periodic structure 126 in the form of a vdW crystal for exemplary purposes, as well as freedom in controlling the distance from the source to the window. The distance from the source to the window 122 can be used to control the angular spread and bandwidth of the X-rays 124 emerging from the window 122. The size of each window e.g., 122 is also adjustable in an example embodiment. The scenario where the windows e.g. 122 can be swivelled not only 360 degrees in the plane of the drawing in FIG. 2, but also 360 degrees in the direction in/out of the plane, can also be implemented in an example embodiment, so that any particular window e.g. 122 (and the sample e.g. 120 it opens to) can be moved to any particular point in three-dimensional space with respect to the periodic structure 126. The option of this versatile window design applies to all embodiments described herein. Also shown is a turbo pump 123 for evacuating the vacuum 125 in an example embodiment.

### Periodic Structures According to Example Embodiments

Although the description focuses on electron beams interacting with van der Waals (vdW) materials to produce X-rays according to example embodiments, the present invention, as mentioned above, is applicable to, and should be understood to include, all kinds of crystalline materials, including artificial materials such as metamaterials, metasurfaces and photonic crystals; all kinds of charged particles beams, including positrons and ions; and all kinds of output photon energies, from microwave to gamma ray emission.

### Collected X-Ray Photon Energy According to Example Embodiments

The energy of the collected X-ray photons according to an example embodiment is given by

$${E}_{p h} = \frac{F}{n H ( 1 + \sqrt{1 - \frac{{n}^{2} - 1}{ℏ c {n}^{2} {H}^{2}} F} )} , \qquad ( 1 )$$

$$Where F = ℏ {cg}^{2} + 2 {g}_{1} {β}_{i} {E}_{i} ,$$

$$H = \frac{{E}_{i}}{ℏ c} ( {β}_{i} cos ( {θ}_{o b s} ) - \frac{1}{n} ) + {g}_{1} cos ( {θ}_{o b s} ) + {g}_{2} sin ( {θ}_{o b s} ) cos ( {φ}_{o b s} ) + {g}_{3} sin ( {θ}_{o b s} ) sin ( {φ}_{o b s} )$$

$$g = ( {g}_{1} , {g}_{2} , {g}_{3} ) = ( g cos ( {θ}_{g} ) , g sin ( {θ}_{g} ) cos ( {φ}_{g} ) , g sin ( {θ}_{g} ) sin ( {φ}_{g} ) )$$

is the grating vector,

$$g = \vert g \vert = m \frac{2 π}{d} ,$$

m is the order of X-ray radiation, d is the periodicity of the periodic structure, βᵢ=vᵢ/c is the normalized initial velocity of the incident electrons, Eᵢ is the initial total energy of the incident electrons, ℏ is the reduced Planck constant, c is the vacuum speed of light, θ_{obs}(θ_{g}) and φ_{obs}(φ_{g}) are azimuthal angle, and polar angle of the X-ray windows (grating vector) and n is the refractive index of the vdW crystal.

Equation (1) is valid for any incident electron energy and any periodic materials. For most materials, the refractive index n is nearly 1 at X-ray frequencies. Therefore, the equation (1) can be simplified as

$${E}_{p h} \approx \frac{F / 2}{\begin{matrix}\frac{{E}_{i}}{ℏ} ( {β}_{i} cos ( {θ}_{o b s} ) - 1 ) + {g}_{1} cos ( {θ}_{o b s} ) + \\ {g}_{2} sin ( {θ}_{o b s} ) cos ( {φ}_{o b s} ) + {g}_{3} sin ( {θ}_{o b s} ) sin ( {φ}_{o b s} )\end{matrix}} . \qquad ( 2 )$$

Equation (2) will be used to predict the energy of emitted X-ray photons according to example embodiments. It is noted that equations (1) and (2) may be re-written in a different way as equations (14) and (15) discussed below.

### Tunability of the Collected X-Ray Photon Energy Via X-Ray Window Rotation According to an Example Embodiment

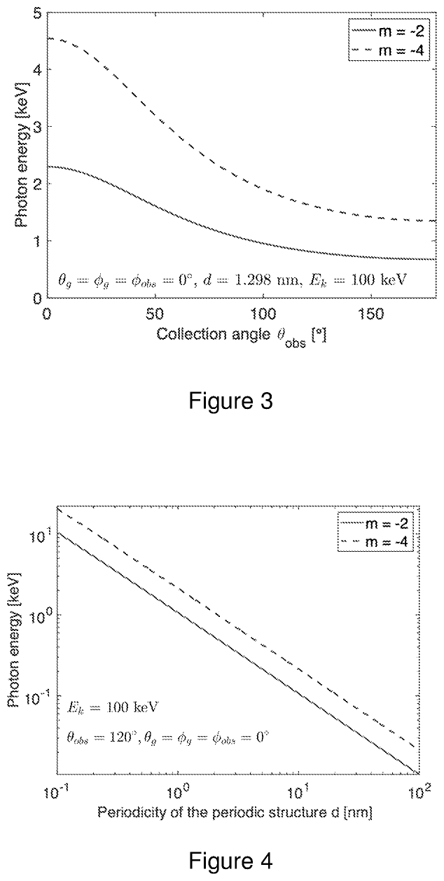

FIG. 3 shows the collection angle dependence of the emitted X-ray photon energy according to an example embodiment, where the periodic structure is vdW single crystal WSe₂ and the kinetic energy of the incident electrons is 100 keV. The photon energy of X-rays decreases smoothly with the increase of the collection angle, which indicates we can tune the energy of the collected X-ray photons by rotating the X-ray window. A multi-window design (compare FIGS. 1 and 2) preferably enables the usage of multi-color X-rays at one time, e.g. from different emission orders m=−2 and m=−4, as a non-limiting example.

### Tunability of Collected X-Ray Photon Energy Via the Periodic Structure Design According to an Example Embodiment

FIG. 4 shows that the energy of collected X-ray photons is tunable via the periodic structure design i.e., changing the periodicity of the periodic structure d, according to an example embodiment.

### Tunability of Collected X-Ray Photon Energy Via Varying the Incident Electron Kinetic Energy (Electron Energy Tunability) According to an Example Embodiment

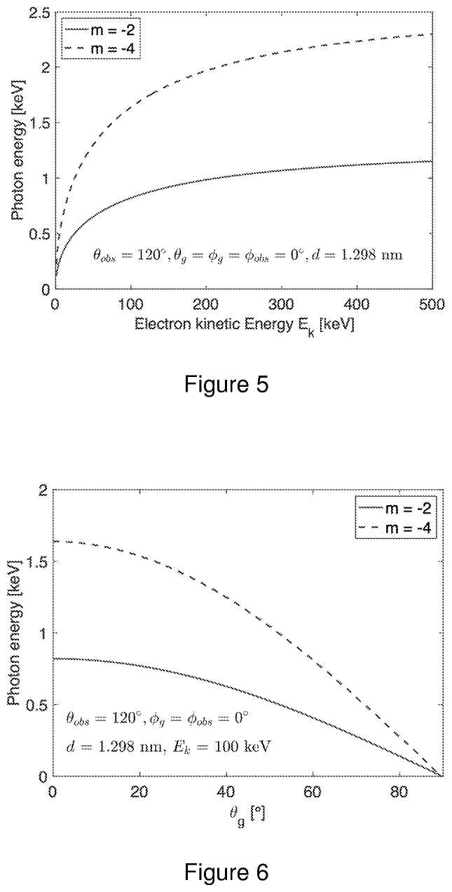

Keeping all other conditions unchanged, the collected X-ray photon energy according to an example embodiment is tunable via varying electron kinetic energy (see FIG. 5). Higher energy electrons emit higher energy X-ray photons. The periodic structure is vdW single crystal WSe₂.

### Tunability of Collected X-Ray Photon Energy Via Varying the Periodic Structure Tilt (Structure Tilt Tunability) According to an Example Embodiment

FIG. 6 shows that the collected X-ray photon energy according to an example embodiment is also tunable via varying the periodic structure tilt angle where the periodic structure is vdW single crystal WSe₂.

### Experimental Data of Electron Energy Tunability According to an Example Embodiment

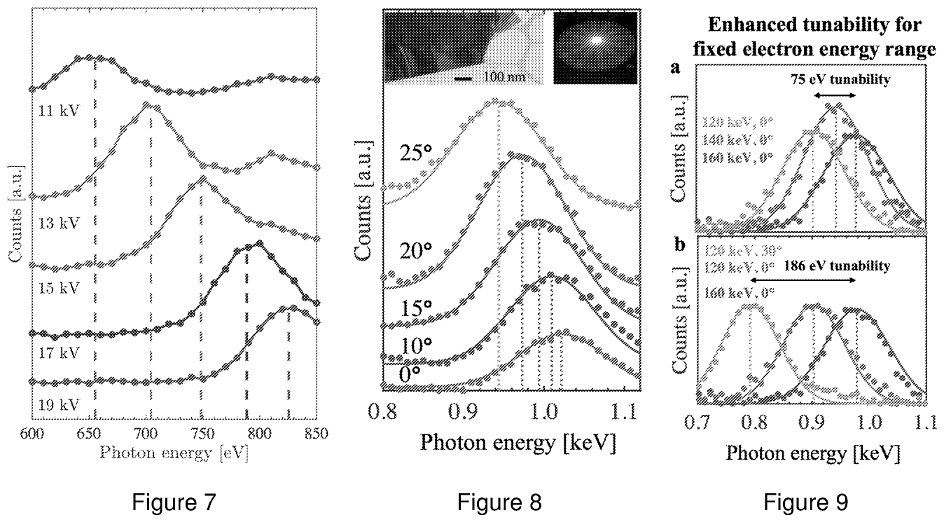

FIG. 7 shows data from a tunable X-ray source according to an example embodiment generated by the interaction of SEM free electrons with graphite single crystal. The filled circles are experimental results and solid curves are guides to the eye. The dashed vertical lines are the theoretical value of the X-ray peaks. This shows that the energy of collected X-ray photon energy is tunable by changing the acceleration voltage of the electron gun, and hence the electron energy (the value of the corresponding acceleration voltage is used to label the curves).

### Experimental Data of Structure Tilt Tunability According to an Example Embodiment

FIG. 8 shows data of the tunability of X-ray radiation via varying the tilt angle of the periodic structure, according to an example embodiment. The spectrum is generated by a 200 keV electron beam moving in WSe₂ single crystal (left top insert shows its TEM image) with various values of θ_{g}, which is the angle between the incident electron beam and the [001] zone axis of WSe₂. The angle is well-calibrated based on Kikuchi bands (right top insert). Here the filled circles and the solid curves are the experimental and theoretical results, respectively.

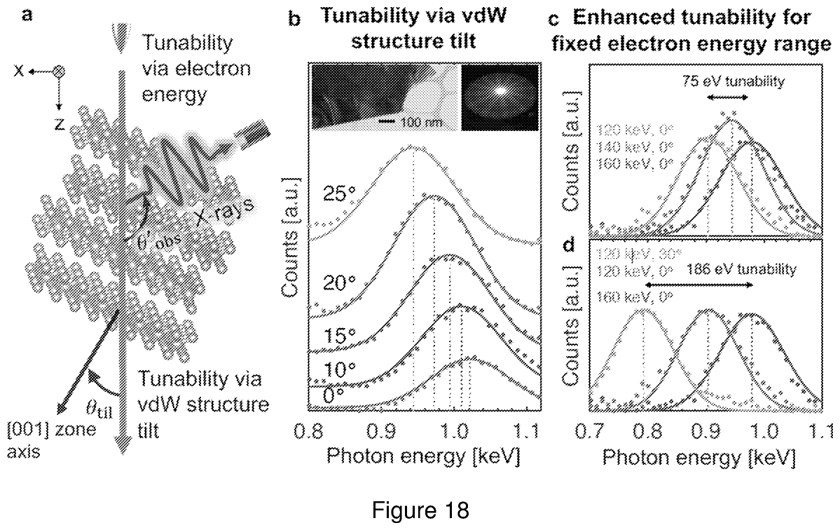

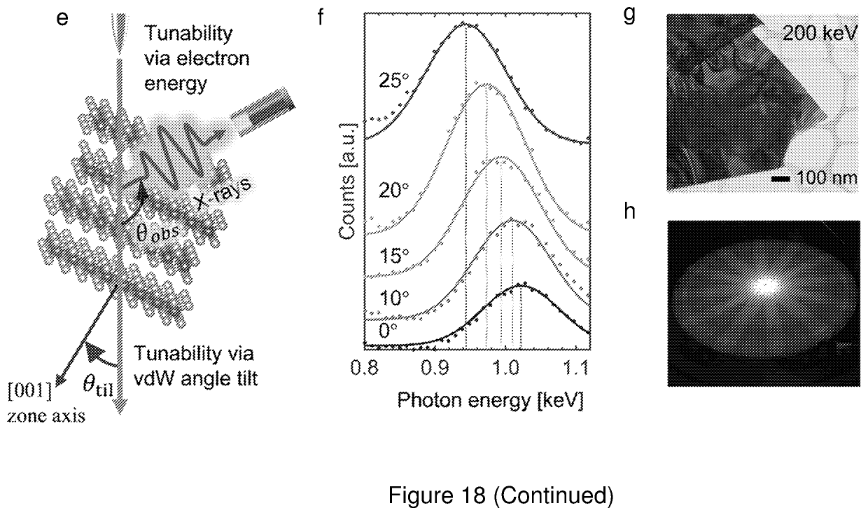

In the experiments on example embodiments the emitted X-rays were measured using energy dispersive X-ray spectroscopy (EDS) detectors. The average radiation intensity per electron of a large, incoherent electron beam can be obtained as

$$〈 \frac{{d}^{2} N}{d ω d Ω} 〉 = \frac{1}{{N}_{e}} \frac{α ω}{4 {π}^{2} {c}^{2}} {\sum }_{i = 1}^{{N}_{e}} {\vert {\int }_{0}^{{t}_{L}} d t {v}_{i} ( t ) \cdot {E}_{k s} ( {r}_{i} , ω ) {e}^{- i ω T} \vert}^{2} , \qquad ( 3 )$$

where N is defined as the number of emitted photons, ω is the angular frequency of the emitted photon, Ω is the solid angle, Ne is the number of incident electrons on the crystal, α is the fine-structure constant, c is the speed of light in free space, t_{L} is the interaction time of the electron with the crystal, vᵢ(t) is the velocity of electron, obtained via the relativistic Newton-Lorentz equation, Eₖₛ(rᵢ, ω) is an eigenmode of the crystal, k is the wave vector of the radiation field, s is the index of the polarization, and rᵢ is the trajectory of the electron. The derivation of equation (3) includes relativistic corrections for the incident electron, summing over all the radiation arising from the various reciprocal lattice vectors g, and averaging over the initial positions of the electron on the crystal surface. Although the focus is on electrons according to example embodiments, the theory is valid for any charged particle when the corresponding values for charge and rest mass are used. This approach has advantages over approaches that consider PXR and CB using separate theoretical frameworks, as it is able to capture the effects of interference between PXR and CB processes, as well as the presence of higher-order processes beyond PXR and CB. The peak photon energy of the output X-rays is obtained from the result of equation (3) as

$$E = ℏ c \frac{{β}_{0} \hat{z} \cdot ( \hat{U} {g}_{0} )}{1 - {β}_{0} cos {θ}_{o b s}^{′}} , \qquad ( 4 )$$

where ℏ is the reduced Planck constant, β₀=v₀/c, v₀ being the initial speed of the incident electron, \hat{z}·(Ûg₀)=(−sin ϕₜᵢₗ cos θₜᵢₗ)g₀ₓ+(sin ϕₜᵢₗ sin θₜᵢₗ)g_{0y}+(cos θₜᵢₗ)g_{0z}, where Û is the unitary matrix and g₀ is the reciprocal lattice vector in the unrotated frame, i.e., when θₜᵢₗ=ϕₜᵢₗ=0°, ϕₜᵢₗ is the rotation angle of the crystal with respect to the z-axis and θ′_{obs} is the effective angle between the electron beam and the observation direction as shown in FIG. 18A. Taking the X-ray peak broadening due to electron beam divergence, the detector energy resolution, and the shadowing effect into account, the following expression for the measured bandwidth of the PCB peaks can be obtained

$$Δ {E}_{tot} \approx {[ {( 5.6 \frac{{ℏν}_{0}}{L} )}^{2} + {( \frac{ℏ c {β}_{0} \hat{z} \cdot ( \partial \hat{U} {g}_{0} / \partial {θ}_{til} )}{1 - {β}_{0} cos {θ}_{o b s}^{′}} Δ {θ}_{e} )}^{2} + {R}^{2} + \\ {E}^{2} ( \frac{βsin ( {θ}_{o b s}^{′} )}{( 1 - βcos {θ}_{o b s}^{′} )} {Δθ}_{o b s}^{′} ) ]}^{1 / 2} , \qquad ( 5 )$$

where L is the interaction length and R is the energy resolution of the energy dispersive X-ray spectroscopy (EDS) detector. In determining the actual observation angle θ′_{obs} and its angular spread Δθ′_{obs} in equation (5), the shadowing effect is taken into account, which causes the effective observation angle to increase (the effective observation angular spread to decrease) by a few degrees from its default value θ_{obs} (Δθ_{obs}). This deviation is due to the edge of the sample holder partly blocking the output X-rays on their way towards the EDS detector. The first term in equation (5) corresponds to the intrinsic bandwidth of the PCB X-ray peak obtained from equation (3), which is on the order of 1 eV in our case. The second term corresponds to effects of electron beam divergence. In the experiments the beam divergence Δθₑ≈1 mrad. The third term accounts for the energy resolution of the EDS detector. The final term accounts for the finite range of observation directions admitted by the angular aperture of the EDS detector. FIGS. 8A and B show good agreement between the experimental measurements (filled circles) with the predictions of the theory (solid lines).

### Experimental Data of the Enhanced Tunability by Simultaneously Controlling Both Electron Energy and Periodic Structure Tilt According to an Example Embodiment

FIG. 9 shows data illustrating that enhanced tunability is achieved by simultaneously tuning both incident electron energy and WSe₂ single crystal tilt angle according to an example embodiment. The accessible X-ray radiation range is more than doubled from 105 eV to 226 eV by the combined tunability. The dominant advantage of vdW angle tunability over electron energy tunability is simple in manipulation since there is no needs to stabilize the electron gun and realign the electron beam. Furthermore, combining vdW angle tunability and electron energy tunability allows much wider photon energy ranges to be accessible compared to using electron energy tunability alone.

### Highly Tunable X-Ray Sources Based on Smith Purcell Radiation According to an Example Embodiment

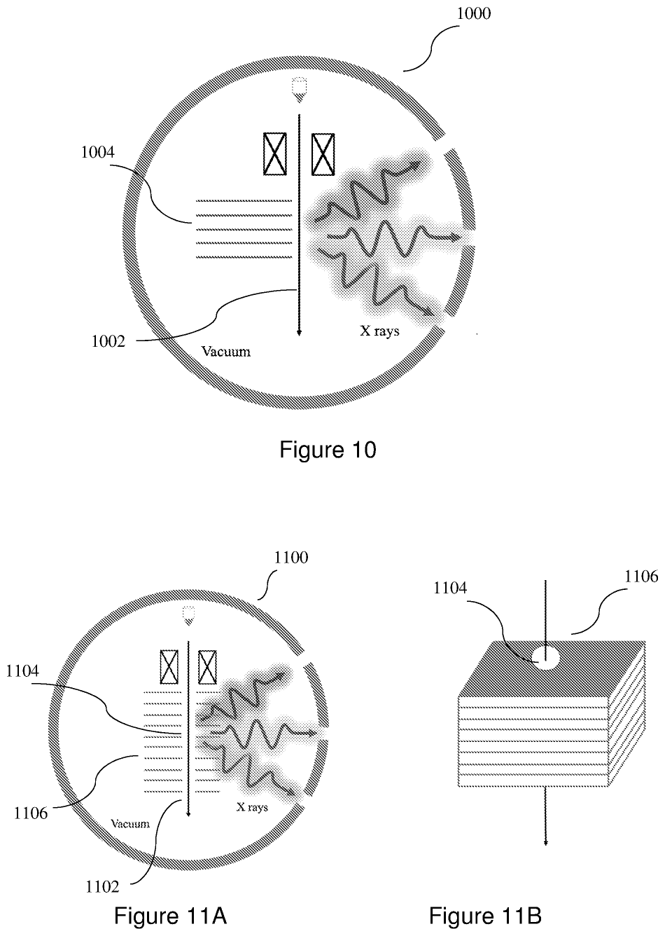

FIG. 10 shows a tunable X-ray source 1000 generated by the interaction of free electrons 1002 with a periodic material 1004 in Smith-Purcell configuration according to an example embodiment.

### Highly Tunable Multi-Colour X-Ray Sources Based on Smith Purcell Radiation According to an Example Embodiment

FIG. 11a shows a tunable X-ray source 1100 generated by free electrons 1102 that penetrate through a hole 1104 of periodic material 1106, according to an example embodiment, where FIG. 11b illustrates a perspective view of the periodic material 1106. In such a configuration, free electrons 1102 are less scattered by the periodic material 1106, which results in a longer scattering mean free path. Therefore, the thickness of the periodic material 1106 can be larger, which enhances the X-ray radiation intensity.

### Highly Tunable X-Ray Sources Based on Channeling Radiation According to an Example Embodiment

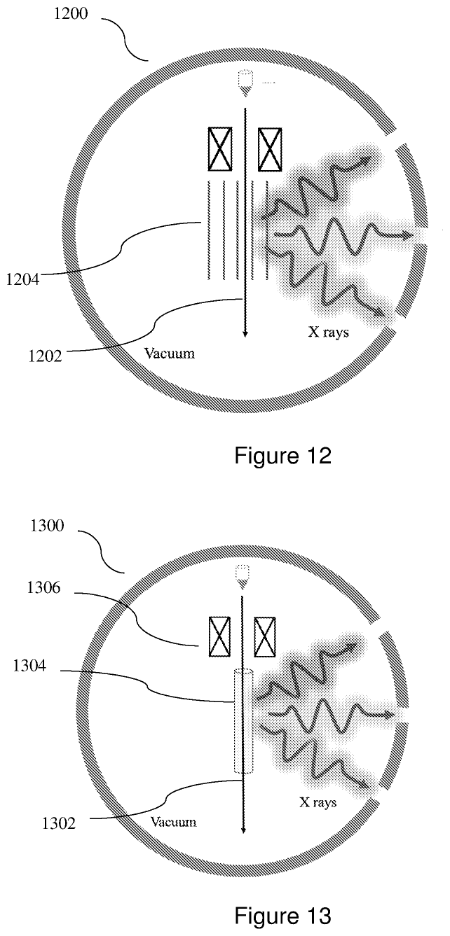

FIG. 12 shows a tunable X-ray source 1200 generated by the interaction of free electrons 1202 with a periodic material 1204 in channeling configuration, according to an example embodiment. This example embodiment is a special case of the embodiment generally illustrated in FIG. 1, i.e. at θ_{g}=90°.

### Highly Tunable X-Ray Sources Based on Channeling Radiation According to Another Example Embodiment

FIG. 13 shows a tunable X-ray source 1300 generated by free electrons 1302 that pass through a nanotube 1304, according to an example embodiment. The nanotube 1304 can be well-studied single- or multi-wall carbon nanotubes. Instead of a single nanotube 1304, the periodic structure could be a nanotube bundle to enhance the radiation intensity in another example embodiment. In general, the periodic structure can be a multi-walled nanotube or a bundle of multi-walled nanotubes—made up of arbitrary materials for each wall—, known as a one-dimensional van der Waals heterostructure.

### Highly Tunable X-Ray Sources Based on Parametric X-Ray Radiation (PXR) According to an Example Embodiment

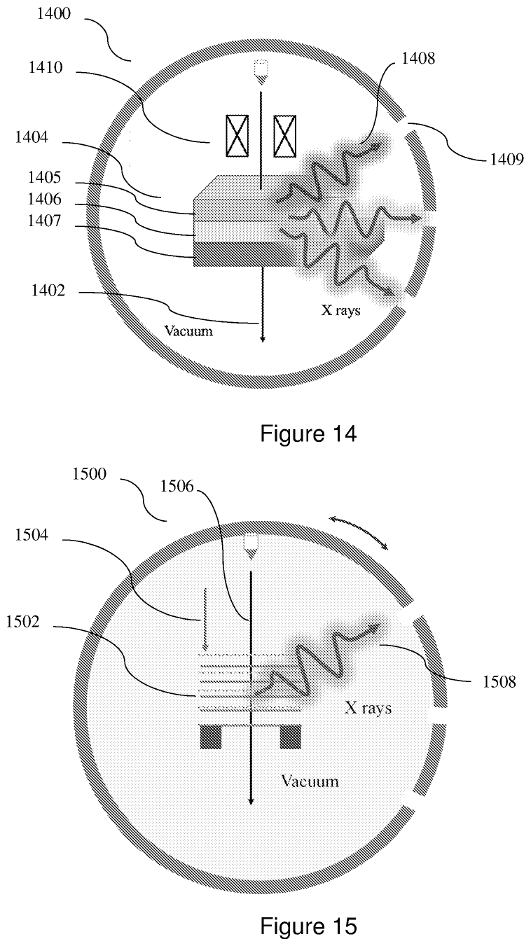

FIG. 14 shows a tunable multi-colour X-ray source 1400 generated by the interaction of free electrons 1402 with multi-layer vdW structure 1404, according to an example embodiment (Here we show three layers 1405-1407 for the purpose of demonstration only). Each layer 1405-1407 is a kind of vdW single crystal with different lattice constants. In such a device, multi-colour X-rays e.g. 1408 are available at each specific window e.g. 1409. The relative radiation intensity of different colour X-ray is tunable via the thickness of each layer 1405-1407 or changing the number of incident electrons on each layer 1405-1407. The energy of multi-colour X-ray 1408 is tunable either via incident electron energy or the tilt angle of the structure 1404, or the choice of materials, in this example embodiment, for a three-layer vdW structure 1404. Additionally, the spectrum of emitted X-rays 1408 can be tailored by twisting each layer in the multi-layer vdW structure with respect to other layers. Examples of these configurations include twisted bilayer graphene and twisted multi-layer graphene.

Real-Time Tunable X-Ray Source Based on Real-Time Control of Mechanical, Electrical and/or Chemical Properties of Target Material According to an Example Embodiment

FIG. 15 shows a tunable multi-colour X-ray source 1500 where the frequency peak and other characteristics of the X-ray source can be controlled by applying mechanical stress, strain, pressure, bending or any kind of deformation to the target material in real-time, by applying force at one or more points of the target material, according to an example embodiment. By way of example, not limitation, the target material 1502 is depicted to be a multilayer vdW material whose interlayer spacing (the spacing between the 2D atomic sheets of the vdW material) have been compressed from the dotted lines to the solid lines by the application of mechanical pressure via a probe 1504. In different embodiments, any kind of electrical or chemical process that the target material 1502 can be subjected to, such as the application of a DC voltage or current, or the triggering of a chemical reaction, can be used. Although not shown in FIG. 15, electron beam shaping elements (compare 1306, 1410 in FIGS. 13,14, respectively) can be included to pre-shape the electron beam 1506 before it is incident upon the target material 1502. Real-time tuning of the output X-rays e.g. 1508 by real-time control over the target material 1502 properties can be combined with real-time control over the electron beam 1506 kinetic energy as well as over the tilt angle of the target material 1502. In an example embodiment, target material properties, electron kinetic energy and target material tilt angle can be simultaneously varied in real-time.

### Potential Applications of the Highly Tunable X-Ray Sources in Computed Tomography (CT) Scan According to Example Embodiments

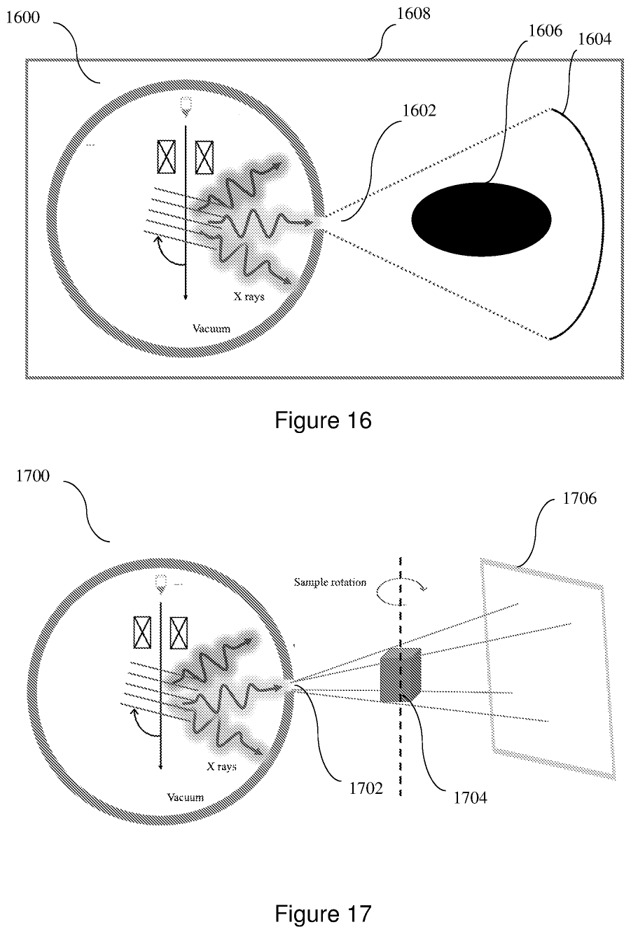

X-ray devices according to example embodiments can provide highly tunable X-ray sources 1600 for computed tomography (see CT detector 1604) scan (see FIG. 16) of a patient 1606. The energy of the X-ray photons e.g. 1602 is tunable via electron kinetic energy, periodic structure tilt, periodic structure design and X-ray window rotation/distance. An X-ray shield 1608 is provided around the treatment area.

### Potential Applications of the Highly Tunable X-Ray Sources in Hyperspectral X-Ray Imaging According to Example Embodiments

X-ray devices according to example embodiment can provide highly tunable X-ray sources 1700 for hyperspectral X-ray imaging (see FIG. 17) of a sample 1704 using a detector 1706 (e.g., imaging plane, spectroscope, CD camera etc.). The energy of the X-ray photons e.g. 1702 is tunable via electron kinetic energy, periodic structure tilt, periodic structure design and X-ray window rotation/distance.

In the following further details of the processes and characteristics according to example embodiments will be described.

Tunable X-ray sources have many promising applications in medicine, industry, and fundamental research. Presently, tunable, high quality X-rays are usually available only at synchrotrons and free-electron lasers. However, the operation of such X-ray sources requires enormous resources in terms of area, energy, and safety precautions, limiting their accessibility. VdW materials are promising candidates for monochromatic, tunable, table-top X-ray sources. Specifically, free electrons interacting with vdW crystals produce X-rays by two mechanisms: parametric X-ray radiation (PXR) and coherent bremsstrahlung (CB), where the emitted photon energy can be tuned by varying the incident electron energy and the atomic composition of the vdW material. In example embodiments of the present invention the versatility of this X-ray source can be substantially enhanced through a mechanism for real-time photon energy tuning: controlling the tilt of the vdW crystal. This tilt angle (θₜᵢₗ in FIG. 18E) is easily adjusted, e.g. via mechanical rotation of the vdW material. Such a method has advantages over tuning based on electron energy or atomic composition, which requires modification of the material or re-alignment of the setup.

FIG. 18A illustrates the method of tuning the emitted X-ray photon energy: by varying the vdW crystal tilt angle θₜᵢₗ, defined as the angle between the incident electron beam and the [001] zone axis of the crystal, according to an example embodiment. Experiments were carried out with 200 keV electrons impinging on a vdW crystal (WSe₂). The resulting photons emitted at the observation angle θ_{obs} are measured by an energy dispersive X-ray spectroscopy (EDS) detector for different crystal tilt angles (see FIG. 18F). A relativistic theory of free electron spontaneous emission in crystalline materials was also developed that not only accounts for both PXR and CBS in the same framework, but also includes arbitrarily higher-order free electron radiation processes. The emitted photon energy peaks of PXR and CBS are

$$E = ℏ {v}_{0} \frac{\hat{z} \cdot ( \hat{R} {g}_{0} )}{1 - ( {v}_{0} / c ) cos {θ}_{o b s}} , \qquad ( 6 )$$

where ℏ is the reduced Planck constant, and v₀ is the initial speed of the incident electron, which travels in the z direction. The expression \hat{z}·(\hat{R}g₀)=(−sin ϕₜᵢₗ cos θₜᵢₗ)g₀ₓ+(sin ϕₜᵢₗ sin θₜᵢₗ)g_{0y}+(cos θₜᵢₗ)g_{0z}, where \hat{R} is the unitary matrix representing the physical rotation of the crystal (i.e., the crystal tilt), g₀ is the reciprocal lattice vector being considered, c is the speed of light in free space, and ϕₜᵢₗ is the rotation angle of the crystal with respect to the z-axis. In FIG. 18F, one sees good agreement between the experimental measurements (points) and theoretical predictions (lines), confirming the viability of tuning the X-ray photon energy by controlling the vdW crystal tilt. Specifically, one observes the peak photon energy varying from 1026 eV to 946 eV when θₜᵢₗ varies from 0° to 25° (all else kept constant).

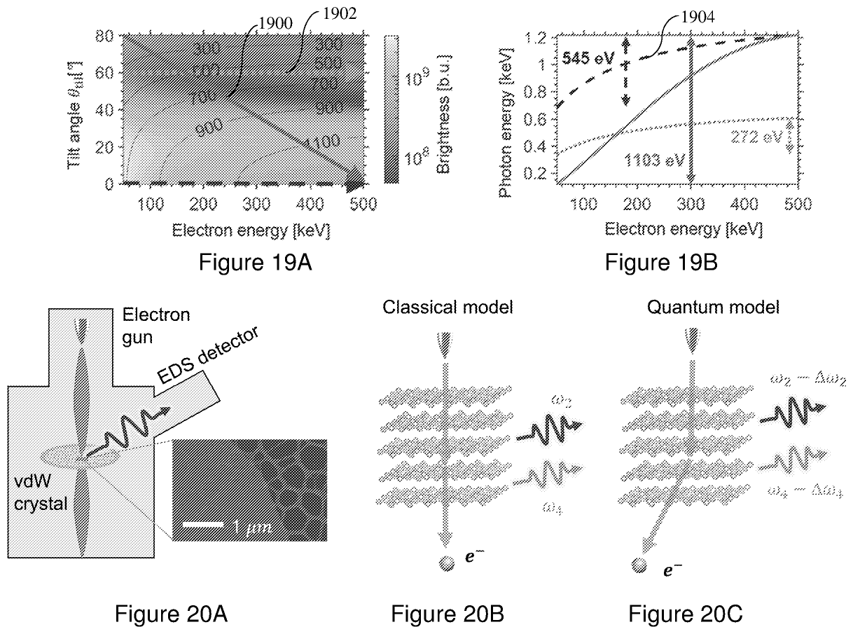

An even wider range of photon energies can be accessed by simultaneously varying both the vdW crystal tilt and the electron energy. FIG. 19A shows the brightness of the emitted X-rays, with overlaid contours corresponding to the peak photon energy predictions of Equation 6. The different arrows 1900 and 1902 in FIG. 19A show that different ways of varying tilt angle and electron energy result in vastly different accessible photon ranges and X-ray intensities. One sees that the broadest photon energy range is accessed by varying the tilt angle and electron energy in an approximately linear fashion (arrow 1900). The corresponding photon energies for all paths depicted in FIG. 19A are shown in FIG. 19B, where one sees that the accessible photon energy range is as large as 1103 eV when the electron energy and the crystal tilt angle are varied simultaneously. This represents an enhancement of over 100% compared to the scenario where only the electron energy is allowed to vary (depicted by horizontal arrow 1902 in FIG. 19A). In this latter scenario, the maximum photon energy range is only about 545 eV (curve 1904 in FIG. 19B). The generated photons are soft X-rays that could, for example, be useful for biological imaging. It is noted that one can also optimize the brightness for any given output X-ray photon energy via the combined tuning mechanism, i.e., controlling both the electron energy and the vdW crystal tilt to achieve maximum brightness, according to an example embodiment.

The brightness of the source used in an example embodiment is about 10⁹ photons s⁻¹ mm⁻² mrad⁻² per 0.1% BW. This compares favorably with those of high harmonic generation in the water-window and conventional X-ray tubes. Furthermore, the peak brightness from the source is proportional to the square of the interaction length L of the electrons impinging on the crystal (∝L²), and proportional to the incident electron beam current. These two parameters can be increased to further enhance the brightness of the vdW source, according to various example embodiments.

In example embodiments, the vdW-based free electron-driven X-ray source can be tuned in real-time by varying the tilt angle of the vdW material. Furthermore, this tuning mechanism can be combined with others—tuning via electron energy and atomic composition—to broaden the accessible photon energy range beyond what can be achieved with a single method. Specifically, the accessible photon energy range can be enhanced by over 100% when the tilt angle and the electron energy are simultaneously varied. The results pave the way to compact, versatile, monochromatic and coherent X-ray sources based on vdW structures, with applications ranging from imaging and fault detection to X-ray quantum optics.

In the Smith-Purcell effect, photons are emitted when an electron's Coulomb field scatters off a periodic structure as the electron travels in constant motion near or through it, in example embodiments of the present invention. The deceleration of the electron upon photon emission, known as quantum recoil, is often assumed to be negligible in the Smith-Purcell effect. This is usually justified when the emitted photon energy is negligible compared to the electron energy. When this is not true, the quantum nature of the radiation and the wave nature of the charged particle can lead to substantial shifts in the output photon energy from its classically predicted value. However, this effect has not been experimentally observed, and a regime for measuring this effect using commonly available electron sources (whose kinetic energies are typically 10-100s of keV) has not been verified.

In the following, theoretical prediction and experimental measurements of the effect of quantum recoil in Smith-Purcell radiation is presented, using 10-13 keV electrons from a scanning electron microscope (SEM) (schematically illustrated in FIG. 20A). Smith-Purcell radiation is generated when the electrons' Coulomb field scatters off the sub-nanometer periodic lattice of the van der Waals (vdW) thin film target (about 100 nm thick). This photon emission process is also known as parametric X-ray radiation (PXR). By measuring the second- and fourth-order PXR photon energies, substantial shifts in the photon energy due to quantum recoil were observed, verifying the accuracy of quantum theory (schematically illustrated in FIG. 20C, which accounts for recoil) over the more popular classical theory where recoil is ignored (schematically illustrated in FIG. 20B). The findings reveal the importance of accounting for quantum recoil in electron-photon interactions, and open the doors to applications where quantum recoil is useful, such as the study of radiation reaction and the quantum free electron laser.

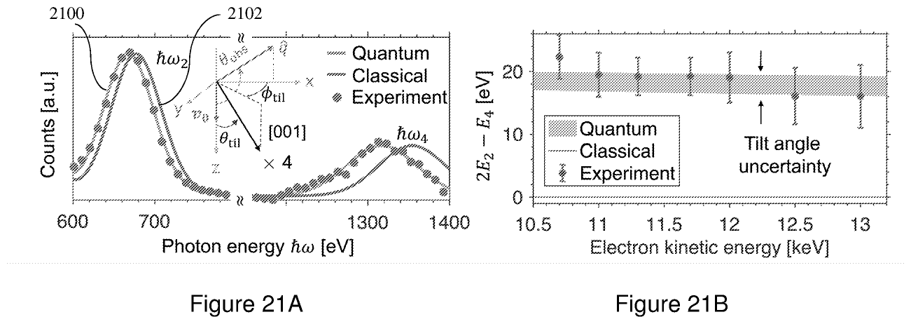

More specifically, Smith-Purcell radiation and PXR are typically modelled using a classical model based on Maxwell's equations, where the electron is assumed to be undeflected throughout the interaction process. The emitted photon energy due to an electron traveling in the z direction through the crystal with speed v₀ is then given by

$${E}_{m}^{0} = {ℏω}_{m} = - \frac{ℏ {g}_{z} {v}_{0}}{1 - {v}_{0} cos ( {θ}_{o b s} ) / c} , \qquad ( 7 )$$

where ℏ is the reduced Planck constant, ωₘ is the angular frequency of the emitted photon of order m, g_{z}=(2 mπ/d)cos(θₜᵢₗ) is the z-component of lattice vector g, d is the interlayer distance of graphite (001) planes, θₜᵢₗ is the polar angle that the [001] zone axis makes with the z direction (see FIG. 21A inset), θ_{obs} is the angle between the emission (also observation) direction and the z direction, and c is the free-space speed of light. The assumption of the non-deflected electron breaks down when conversation of energy and momentum are enforced. In this case, we obtain the emitted photon energy as

$${E}_{m} = ℏ ( {ω}_{m} - Δ {ω}_{m} ) = - \frac{ℏ {g}_{z} {v}_{0} + {ℏ}^{2} {c}^{2} {g}^{2} / 2 {E}_{i}}{1 - {v}_{0} cos ( {θ}_{o b s} ) / c - ℏ cg \cdot \hat{q} / {E}_{i}} , \qquad ( 8 )$$

where Δωₘ denotes the angular frequency shift with respect to the classical approximation Equation (7), Eᵢ is the total energy of the incident electron, \hat{q}=(sin θ_{obs}, 0, cos θ_{obs}) is the unit vector in the observation direction. To arrive at Equation (8), we have used the fact that the refractive index is close to one and the X-ray detector is positioned in the x-z plane. FIG. 21A shows the experimental results (circles) for a 12 keV electron incident on a single graphite crystal. The experiment shows good agreement with theoretical predictions corresponding to Equation (8) (curve 2100), and noticeable discrepancies from that of Equation (7) (curve 2102), confirming the importance of accounting for quantum recoil. To emphasize this, FIG. 21B plots the quantity 2E₂−E₄ for a range of electron energies, where one sees disagreement with the zero-value prediction of the classical model, but good agreement with that of the quantum model.

The findings according to example embodiments represent an unprecedented measurement of quantum recoil in the Smith-Purcell effect. The experiment was performed in an SEM using vdW materials, showing that quantum recoil in electron-photon interactions can be measured using lab-scale technology. By varying the electron energy to 100s of keV (still lab-scale) and controlling the tilt angle of the vdW crystal, even more substantial quantum recoil can be realized. The results also confirm the importance of accounting for quantum recoil in the electron-photon interactions, especially when nanoscale gratings are involved. With growing interest in miniaturized free electron-driven light sources, laser-driven electron accelerators, and the interaction of free electrons with quantum materials, the findings pave the way to further fundamental studies and technology development based on quantum effects on a laboratory scale.

In example embodiments of the present invention, the quantum wave nature of electrons provides new degrees of freedom for controlling light emission via electron waveshaping and can lead to the emergence of more versatile and powerful light sources.

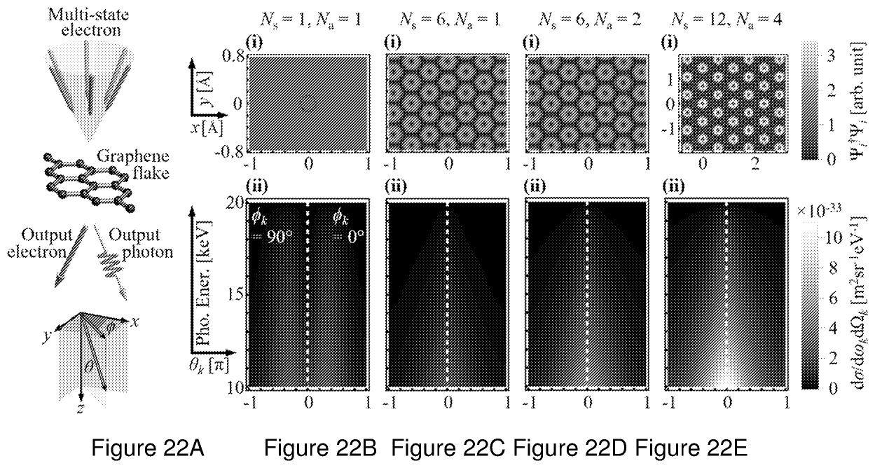

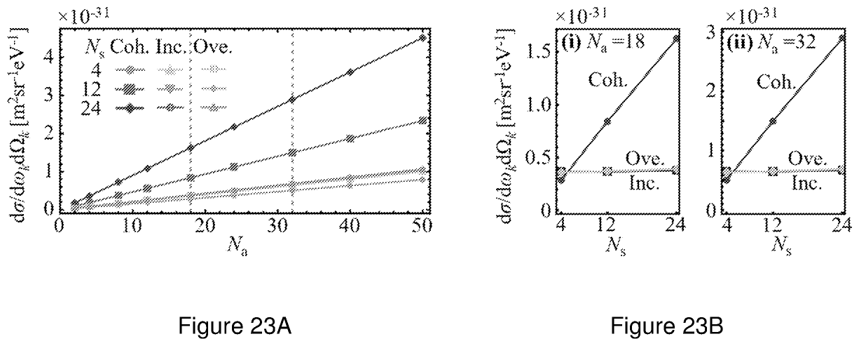

In example embodiments, electron waveshaping can be used to control and substantially enhance bremsstrahlung, the spontaneous emission of photons when electrons decelerate in the presence of atomic nuclei. Bremsstrahlung is responsible for the majority (>90%) of photon emission from X-ray tubes, which are the prevalent source of X-rays in the majority of medical, industrial and security applications today. The ability to effectively manipulate and substantially enhance bremsstrahlung according to example embodiments is thus highly sought after. It was found that by tailoring the input momentum eigenstates that compose the electron wavepacket, one can control both the emission directionality and intensity. One can enhance the directionality and intensity even further by adding more electron states and atoms (see FIG. 22). A graphene flake was used as an exemplary platform (see FIG. 22A), although the conclusions can be extended to any general crystalline configuration of atoms. Additionally, the results reveal that the enhanced bremsstrahlung truly arises from quantum interference between the emission processes associated with different electron states, and cannot be trivially explained through greater localization of the electron wavefunction about the scatterers (see FIG. 23).

The predictions rely on an exact solution of the interaction using quantum electrodynamics (QED), believed to have been solved for the first time for a shaped incoming electron scattered by a multi-atom potential. The Dirac free electron wavefunction is denoted by Ψᵢ, consisting of Nₛ discrete electron momentum eigenstates, and interacting with Nₐ atoms graphene lattice. The electron population density distribution in real space is given by Ψᵢ^{†}Ψᵢ(x) with position vectors x, is temporally static due to its mono-energy. We obtain the following expression for the differential (diff.) cross section of bremsstrahlung:

$$\frac{d σ}{d {ω}_{k} d {Ω}_{k}} = \frac{{ω}_{k} \vert {p}_{f} \vert}{8 {{ε}_{0} ( ℏ c )}^{3} {( 2 π )}^{5} \vert {p}_{j} \vert} {( \frac{Z {q}_{e}}{{ε}_{0}} )}^{2} {\sum }_{m , {m}^{′} = 1}^{{N}_{s}} \vert {N}_{{m}^{′}} \vert \vert {N}_{m} \vert {e}^{i ( {ψ}_{m} - {ψ}_{{m}^{′}} )} {\sum }_{n , {n}^{′} = 1}^{{N}_{a}} \int d {Ω}_{f} \frac{1}{4} {\sum }_{r , {s}_{f}} {\sum }_{j , {j}^{′}} {C}_{{j}^{′}} {C}_{j} {Z}_{m , {m}^{′} , n , {n}^{′} r , {s}_{f} , j , {j}^{′}} , \qquad ( 9 )$$

$$where$$

$${Z}_{m , {m}^{′} , n , {n}^{′} , r , {s}_{f} , j , {j}^{′}} ≡ [ {M}_{{p}_{k} {p}_{f} {p}_{i , {m}^{′}}}^{{rs}_{f} {s}_{i}} {e}^{{ik}_{{m}^{′}} \cdot {d}_{{n}^{′}}} ] * {{[ {M}_{{p}_{k} {p}_{f} {p}_{i , m}}^{{rs}_{f} {s}_{i}} {e}^{{ik}_{m} \cdot {d}_{n}} ] [ {( {μ}_{{j}^{′}} / {a}_{0} )}^{2} + {\vert {k}_{{m}^{′}} \vert}^{2} ]}^{- 1} [ {( {μ}_{j} / {a}_{0} )}^{2} + {\vert {k}_{m} \vert}^{2} ]}^{- 1} ,$$

ℏ is the reduced Planck's constant, c the speed of light in vacuum, Z the atomic number, qₑ the electron charge, ε₀ the permittivity of free space, a₀ the Bohr radius, ωₖ the photon angular frequency, Ωₖ, Ω_{f} the solid angles of output photon and electron momentum respectively, p the 4-momentum, p the 3-momentum, Mₚ_{ₖ}ₚ_{_{f}}ₚ_{_{i,m}}^{r s}^{_{f}}^{s}^{ᵢ} the bremsstrahlung scattering matrix computed from second order Feynman diagram, wavevector kₘ=(p_{i,m}−pₖ−p_{f})/ℏ where subscript i, f, k corresponds to input electron, output electron and output photon respectively, dₙ the lattice constant vectors of n^{th} atom in the graphene, and Cⱼ,μⱼ are constants from the screening functions of carbon atom. Nₘ, ψₘ are the respective amplitude and phase for the m^{th} discrete electron state of momentum p_{i,m} (|p_{i,m}=|pᵢ| for all m). The variables Nₘ, ωₘ may be controlled to tailor the shape of the input electron wavepacket. The static potential of a graphene flake comprising Nₐ atoms is modelled by a multi-atom Yukawa potential A_{N}_{ₐ}^{Yuk}(x). A function O_{A} is also defined to quantify the degree of overlap between the electron probability distribution and the atomic potential: O_{A}=[∫_{-∞}^{∞}A_{N}_{ₐ}^{Yuk}(x)Ψᵢ^{†}Ψᵢ(x)d³x][(Zqₑ/ε₀) Σⱼ Cⱼ (μⱼ/a₀)⁻²]⁻¹. In FIG. 23, one observes that the incoherent (“Inc.”—overlaid by the “Ove” curves in FIG. 23A) emission is related to normalized Yukawa potential overlapping function O_{A} via a constant C_{Inc}=2×10⁻³ [m²sr⁻¹ eV⁻¹] as [dσ/dωₖdωₖ]_{Inc}≈C_{Inc}O_{A}.

FIG. 22 shows how the bremsstrahlung output can be made directional by increasing the number of electron states from one (FIG. 22B) to six (FIG. 22C), resulting in a structured electron population density as shown in FIG. 22C(i). Further increases in either number of electron states or number of atoms leads to larger emission rates, while maintaining the directional profile of the bremsstrahlung output (FIGS. 22C-E). The fundamental realization at the core of the findings is that for coherent interference, the constituent input electron states must have momenta difference Δp matching the corresponding lattice vectors d of the crystal via the relation Δp·d=2lπ, l being some integer. This results in a scaling law for coherent X-ray output (FIG. 23A “Coh.”) that is different from that for regular (incoherent) bremsstrahlung (FIG. 23A, “Inc.”). FIG. 23A also plots the normalized degree of overlap between the electron probability distribution and the atomic potential C_{Inc}O_{A} (“Ove.”). It is noted that the incoherent emission (“Inc.”) overlaps almost perfectly with the “Ove.” curves in FIGS. 23A and 23B. This indicates that changes in incoherent emission with varying Nₐ and Nₛ are readily explained through the localization of the electron wavefunction about the atoms: a greater chance of finding electrons near the atoms naturally favours a larger chance of bremsstrahlung. Coherent emission, however, arises from quantum interference between different emission processes (each corresponding to a particular input electron momentum eigenstate), and can be enhanced through further electron waveshaping (increasing Nₛ), as sees in FIG. 23B.

It is hence shown that shaped electrons can be used to tailor and enhance the properties of free electron spontaneous emission in crystalline materials, according to example embodiments. In particular, incoherent and non-directional bremsstrahlung can be made both coherent and directional via free electron waveshaping. The output intensity can be substantially enhanced by using more atoms and further structuring the electron wavepacket (i.e. by including more momentum eigenstates). The findings reveal the central role of interference between different QED processes in shaping free electron radiation according to example embodiments, and pave the way to greater control over bremsstrahlung for X-ray imaging and other applications.

Example embodiment of the present invention open up intriguing dimensions of design and exploration for free electron-driven X-ray sources, by demonstrating the use of multilayer vdW heterostructures for multi-color X-ray emission. The results show that the ability to build atomically precise vdW heterostructures directly translates into the ability to generate X-ray spectra with precisely tailored relative intensities and peak photon energies. Such a source according to an example embodiment has potential applications in multi-color X-ray pump-probe experiments, and quantum optics.

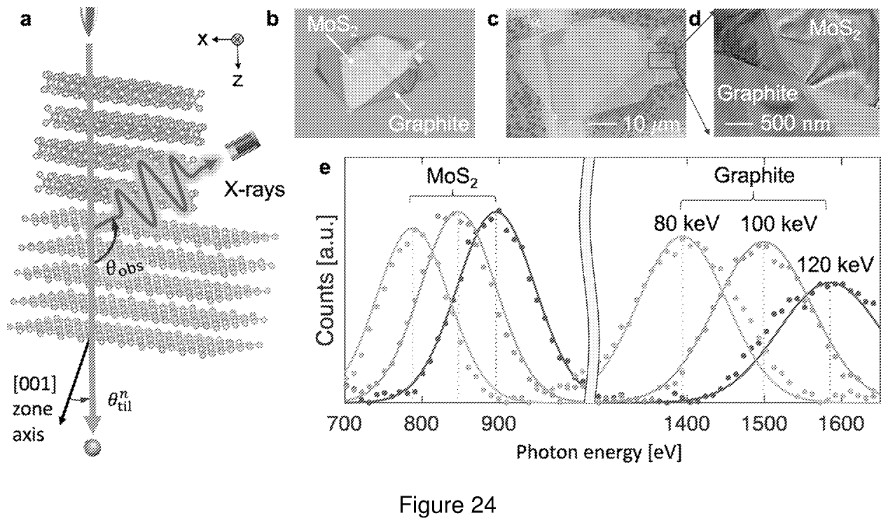

As shown in FIG. 24A and discussed above, the passage of a free electron beam through a van der Waals (vdW) heterostructure generates X-rays due to parametric X-ray radiation (PXR) and coherent bremsstrahlung (CB). PXR is emitted by the polarization currents in the vdW heterostructure induced by the incident electron beam, and can be regarded as an atomic version of Smith-Purcell radiation. At the same time, the undulation of the electron beam by the periodic crystal potential generates coherent bremsstrahlung (CB) X-ray radiation. These two types of X-ray radiation (PXR and CB) share the same output X-ray photon energies in our regime of interest, and are collectively referred to as parametric coherent bremsstrahlung (PCB).

The peak energy of the output PCB X-rays generated from a single crystal is given as

$$E = ℏ c \frac{{β}_{0} \hat{z} \cdot ( \hat{U} {g}_{0} )}{1 - {β}_{0} cos {θ}_{o b s}} , \qquad ( 10 )$$

where ℏ is the reduced Plank constant, c is the speed of light in free space, β₀≡v₀/c (v₀ being the electron velocity), θ_{obs} is the angle between the electron beam and the observation direction, g₀ is the reciprocal lattice vector in the unrotated frame with g₀=2πm/d₍₀₀₁₎, m being an integer, d₍₀₀₁₎ being the interlayer distance of (001) planes, \hat{z}·(Ûg₀)=−(sin ϕₜᵢₗ cos θₜᵢₗ)g₀ₓ+(sin ϕₜᵢₗ sin θₜᵢₗ)g_{0y}+(cos θₜᵢₗ)g_{0z}. Here Û is the rotation matrix, θₜᵢₗ is the angle between the incident electron and the [001] zone axis of the vdW material (FIG. 1a), ϕₜᵢₗ is the rotation angle of the crystal about the z-axis. The ϕₜᵢₗ is performed after the θₜᵢₗ.

In vdW heterostructures, each layer of single-crystal material has different g₀ which results in multicolor PCB radiation, according to example embodiments. The peak photon energies agree with those predicted by Equation (10) for each of the constituent vdW material layers. The average PCB radiation intensity per electron of a large electron beam can be obtained as

$$〈 \frac{{d}^{2} N}{d ω d Ω} 〉 \approx {\sum }_{n = 1}^{{N}_{m}} [ \frac{1}{{N}_{e}^{n}} \frac{α ω}{4 {π}^{2} {c}^{2}} {\sum }_{i = 1}^{{N}_{e}^{n}} {\vert {\int }_{0}^{{t}_{n}} {v}_{i}^{n} ( t ) \cdot {E}_{ks}^{n} ( {r}_{i} , ω ) {e}^{- i ω t} dt \vert}^{2} ] , \qquad ( 11 )$$

where N is the number of emitted photons, ω is the photon angular frequency, Ω is the solid angle, n denotes the vdW material type in the heterostructure, Nₘ is the number of vdW material types, Nₑⁿ is the number of incident electrons, α is the fine-structure constant, tₙ is the interaction time of the electron with vdW material n, vᵢⁿ(t) is the velocity of the electron, Eₖₛⁿ(rᵢ, ω) is an eigenmode of the crystal, k is the wave vector of the radiation field, s is the index of the polarization, rᵢ is the trajectory of the electron. The intrinsic bandwidth of PCB is on the order of 1 eV. However, the measured bandwidth is significantly broadened due to the electron beam divergence Δθₑ, the energy resolution R of the energy dispersive spectroscopy (EDS) detector, and the finite observation angle range Δθ_{obs} of the EDS detector. By taking these effects into consideration, the measured bandwidth of the PCB peaks is

$$Δ {E}_{t o t} \approx \sqrt{{( 5.6 \frac{ℏ {v}_{0}}{{L}^{n}} )}^{2} + {R}^{2} + {( \frac{ℏ c {β}_{0} \hat{z} \cdot ( \frac{\partial \hat{U} {g}_{0}}{\partial {θ}_{til}^{n}} )}{1 - {β}_{0} cos {θ}_{obs}} {Δθ}_{e} )}^{2} + {( \frac{E {β}_{0} sin {θ}_{til}^{n}}{1 - {β}_{0} cos {θ}_{obs}} {Δθ}_{obs} )}^{2}} \qquad ( 12 )$$

where Lⁿ is the interaction length of incident electron in vdW material type n. The first term under the square root in equation (12) describes the intrinsic bandwidth. The second term is the energy resolution of the EDS detector where R≈97 eV in our case. The third term accounts for the electron beam divergence. In the electron source used according to an example embodiment, Δθₑ≈1 mrad, which results in a negligible contribution to the measured bandwidth. The final term describes the broadening due to the finite range of the observation angles.

Multicolor X-ray generation in a MoS₂/graphite heterostructure comprising a layer of MoS₂ on a layer of graphite was experimentally demonstrate and theoretically predicted, according to example embodiments. To fabricate this heterostructure in an example embodiment, graphite is mechanically exfoliated onto a silicon substrate coated with 285 nm SiO₂ film. On the other hand, few-layer MoS₂ is mechanically exfoliated onto a PDMS substrate from bulk MoS₂. The few-layer MoS₂ is then transferred on the top of the graphite via dry transfer, resulting in the MoS₂/graphite heterostructure (FIG. 24B). Finally, the heterostructure is transferred onto an Au grid for transmission electron microscopy (TEM) measurements with the aid of the wet transfer method. Scanning electron microscopy (SEM) image of the vdW heterostructure is shown in FIG. 24C. TEM image of the portion where the multicolor X-rays was generated is shown in FIG. 24D. The thickness of graphite and MoS₂ layers in the portion is about 150 nm and 30 nm, respectively, which is measured by convergent beam electron diffraction.

The X-ray measurements according to example embodiments were performed in a chamber that provides a source of free electrons and a high vacuum. The output X-ray spectra are measured by an energy-dispersive X-ray spectroscopy (EDS) detector. FIG. 24E shows the two-color X-ray spectra when the free electron beam impinges on the MoS₂/graphite heterostructure, according to an example embodiment. Two X-ray peaks are clearly observed at photon energies of about 850 eV and 1500 eV, respectively. The X-ray peak around 850 eV (1500 eV) is contributed by the MoS₂ (graphite) layer. The output photon energies are tuned from 788 eV to 896 eV for MoS₂, and from 1394 eV to 1585 eV for graphite when free electron kinetic energy is varied from 80 keV, to 100 keV, to 120 keV. The experimental results (filled circles) are in excellent agreement with theoretical predictions both in photon energy (dotted lines, predicted by equation (10)) and in bandwidth (curves in FIG. 24E), predicted by equation (12)), where θₜᵢₗⁿ is 22.5 degrees and 26.5 degrees for MoS₂ and graphite, respectively. The two layers share a slightly different value of on θₜᵢₗⁿ due to the strain that comes from the uneven surface of the supporting grid and the mechanical forces introduced during the dry transfer. The strain can be reduced by using atomic even substrate and anneal in different example embodiments.

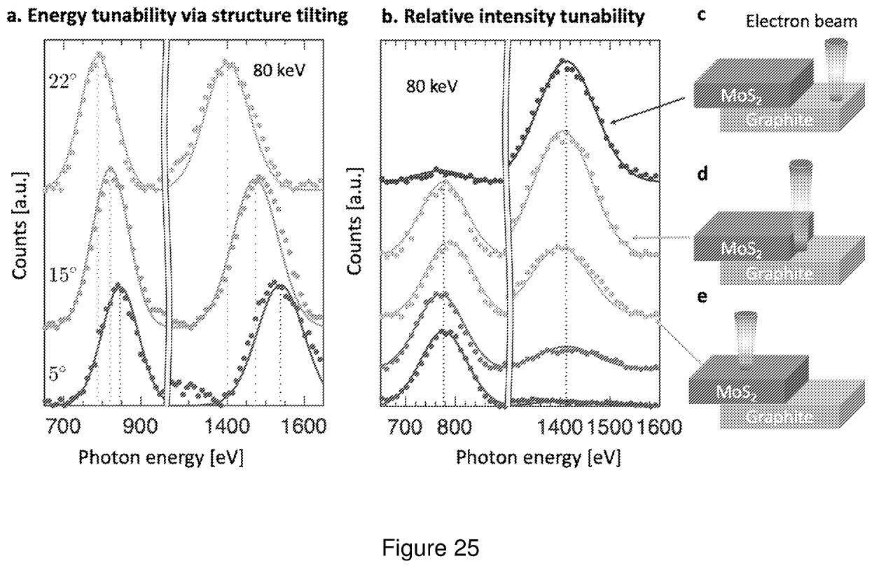

Besides being tunable by varying the electron energy (FIG. 24E), the multicolor X-ray source according to an example embodiment is also tunable by varying the tilt angle of the heterostructure with respect to the impinging electron beam. FIG. 25A shows the X-ray spectra generated by an 80 keV electron incident on the MoS₂/graphite heterostructure. The output X-ray photon energy from the MoS₂ (graphite) layer is tuned from 788 eV to 846 eV (1400 eV to 1538 eV) when the tilt angle θₜᵢₗ^{MoS}^{₂} is varied from 5° to 22° (θₜᵢₗ^{Graphite}+θₜᵢₗ^{MoS}^{₂}+4°), respectively. This is a powerful and practical way to manipulate the output characteristic of X-ray spectra dynamically (i.e., real-time) since it can be achieved by simply tilting the vdW heterostructure, and there is no need to realign the electron beam.

The relative intensity of the multicolor X-ray source according to an example embodiment can also be tailored by controlling the location where the free electron beam impinges on the vdW heterostructure (FIG. 25B). When the electron beam is mainly incident on the pure graphite region (FIG. 25C), X-ray peak intensity from graphite is significantly higher than that from MoS₂, see the corresponding curve in FIG. 25B. By positioning the electron beam to impinge both the pure graphite region and the MoS₂/graphite heterostructure region (FIG. 25D), one observes a relatively strong X-ray peak from graphite and a relatively weak X-ray peak from MoS₂ (see corresponding curve in FIG. 25B). When the electron beam fully impinges on the MoS₂/graphite heterostructure region (FIG. 25E), one observes similarly strong X-ray peaks from graphite and from MoS₂ (see corresponding curve in FIG. 25B). Furthermore, one can obtain a relatively strong X-ray peak from MoS₂ and a relatively weak X-ray peak from graphite by shifting the electron beam towards the pure MoS₂ region (bottom two curves in FIG. 25B). Varying the electron beam position thus enables to smoothly tune the ratio of MoS₂ PCB intensity to graphite PCB intensity from zero to infinity, according to an example embodiment. In FIG. 25B, the peak position is slightly shifted when the electron beam is shifted. This is caused by small undulations in the MoS₂/graphite heterostructure resulting in small changes in the tilt angle θₜᵢₗⁿ. The small undulations are caused by the strain that comes from the uneven surface of the supporting grid and the mechanical forces introduced during the dry transfer.

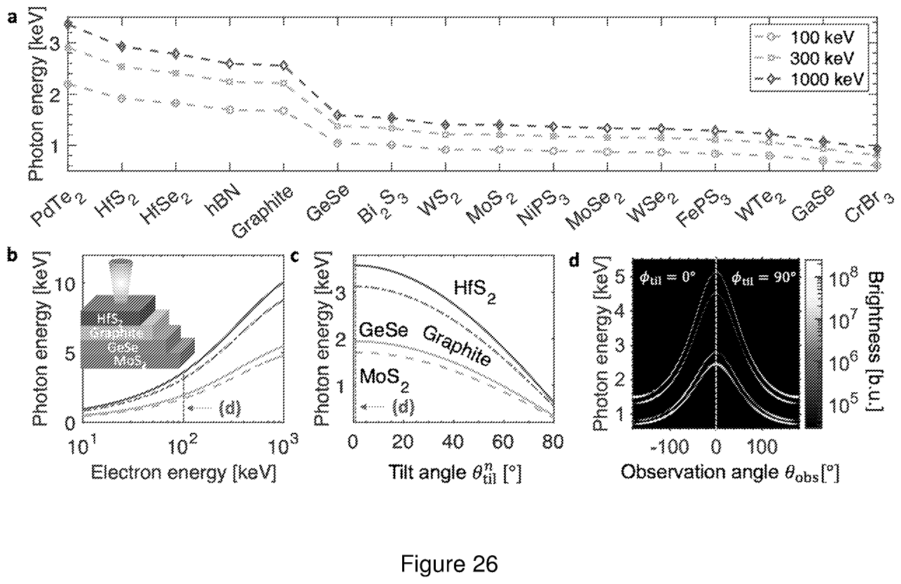

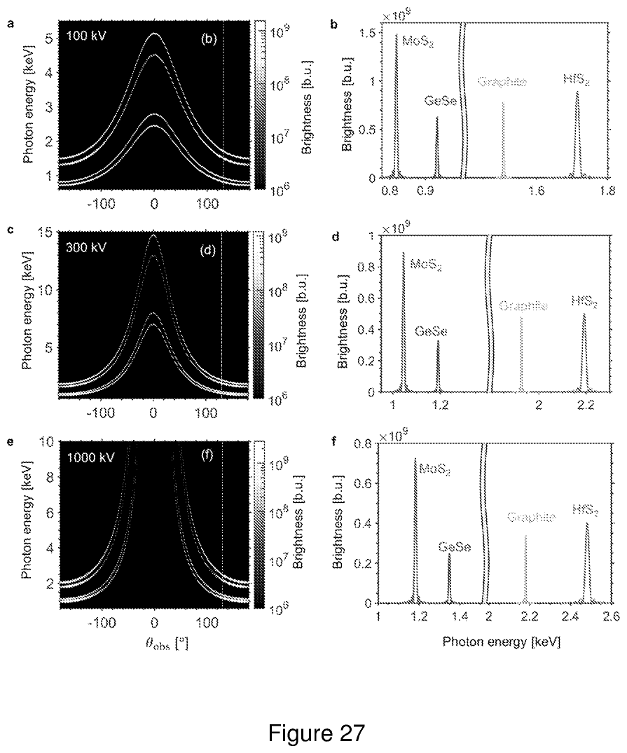

In FIG. 26, the concept of bespoke, tunable X-ray sources based on the PCB mechanism in vdW heterostructures according to example embodiments is presented. Specifically, a multilayer (in this example embodiment four layers) vdW heterostructure can be used to generate X-ray emission spectra with an arbitrary number of peaks, at arbitrary photon energies and of arbitrary relative intensities. As shown in FIG. 26A, the output photon energy decreases with the increasing interlayer distance of the vdW materials (equation 10). The wide range of available vdW materials, as well as the ability to stack them to form heterostructures, provides unprecedented versatility in the design of multicolor X-ray output, according to example embodiments. In principle, one can stack any two or more types of vdW materials to develop multicolor X-ray sources with desired output photon energies, according to various example embodiments. For example, one can stack HfS₂, Graphite, GeSe and MoS₂ to form a vdW heterostructure, according to an example embodiment (the inset of FIG. 26B), and use it to generate four-color X-rays. In this sense, one can tailor the output properties of the multicolor X-ray sources by material design, according to various example embodiments. FIGS. 26B and 26C show the prospect of tuning the constituent output photon energy peaks by varying the electron energy and the heterostructure tilt angle with respect to the electron beam respectively, according to an example embodiment. It is seen that a relatively wide range of photon energies, spanning the soft and hard X-ray regimes can readily be accessed with table-top electron sources, according to example embodiments. The radiation intensity of the X-ray source from 100 keV electrons is shown in FIG. 26D, which is calculated from equation (11). The curves from top to bottom are contributed by HfS₂ (100 nm), graphite (100 nm), GeSe (30 nm), and MoS₂ (15 nm), respectively. In FIG. 27, in addition to the brightness of the X-ray source from 100 keV electrons (FIGS. 27A, B), the brightness of the X-ray source from 300 keV electrons (FIGS. 27C, D) and 1000 keV electrons (FIGS. 27E, F) are shown, as a function of emitted photon energy and the observation angle θ_{obs} (FIGS. 27A, C, E) and observed at 130° observation angle (FIGS. 27B, D, F). The radiation intensity of each peak is tailorable by controlling the thickness of the corresponding vdW layer, according to example embodiments.

Multicolor light sources have been intensively investigated for their potential applications in pump-probe experiments. The tunable multicolor X-ray generation according to example embodiment of the present invention could enable the extension of these applications into the X-ray regime. Additionally, an example embodiment requires neither two electron beams nor two grating crystals as is the case of undulator-based multicolor X-ray sources. In example embodiments, the measured X-ray flux is about 29 photons/s for both MoS₂ and graphite with a 80 keV electron beam incident on MoS₂/graphite heterostructures for electron beam current about 2.5 nA (measured by Faraday cup), which agrees with a theoretical calculation value 22 photons/s. Here the use of the small electron beam current is due to the limited measurement ability of the EDS detector used. In real applications, the electron beam current can be on the order of ampere where the corresponding photon flux is about 10¹⁰ photons/s.

Thanks to the development of laser-wakefield accelerators, gigaelectron volt (GeV) electrons are available in a laboratory. Based on this, the compact X-ray source according to an example embodiment is ready to be extended into the ultrarelativistic region. The penetration depth of electrons increases with the increase of kinetic energy, which makes high energy electrons more favorable in thicker vdW heterostructures. Additionally, by using laser-driven electrons, the mechanism according to example embodiments can be used to develop on-chip multicolor X-ray sources. Furthermore, the scheme according to example embodiments can generate pulsed multicolor X-ray sources by using pulsed electrons.

It is noted that higher-order PCB radiation can also be regarded as a kind of multicolor X-ray source, according to example embodiments. However, the photon energies of the higher-order PCB can only be integer times of the photon energy of the first-order PCB. The radiation intensity of the higher-order PCB is usually weaker than the lower-order and hard to manipulate.

As described, it is shown that vdW heterostructures are a promising platform for developing compact multicolor free electron-driven X-ray sources according to example embodiments. A bespoke X-ray source emitting an arbitrary combination of output X-ray peaks according to an example embodiment can be designed by selecting the specific combination of vdW material layers in the heterostructure. Additionally, the output photon energies can be tuned in over a wide range by varying the electron energy and/or the tilt angle of the vdW heterostructure. Furthermore, the relative intensity of the output X-ray peaks can be controlled by varying the electron beam position. Specifically, it was shown that the ratio of the X-ray peaks in a two-color X-ray source based on a MoS₂/graphite heterostructure can be smoothly tuned from zero to infinity, according to an example embodiment. The results reveal the promise of vdW heterostructures as a platform for the generation of customizable X-ray spectra, for applications in the X-ray regime including multi-color pump-probe spectroscopy, and quantum optics, according to example embodiments.

For the experiments, bulk MoS₂ crystals were synthesized via the chemical vapour transport method. The molybdenum powder and sulfur powder with the stoichiometric ratio of 1:2 were sealed in a silica tube under a high vacuum environment (<10⁻³ Pa), in which 30 mg iodine was also loaded as the transport agent. The sealed tube was put in a horizontal two-zone furnace, whose cold end was heated to 900° C. and another end was heated to 1000° C. within 30 h. After two weeks, the furnace was set to cool down to room temperature within 48 h. Finally, shiny MoS₂ bulk crystals were obtained in the cold end.

The multicolor free electron driven X-ray source from vdW heterostructures was demonstrated using an electron source of the type used in transmission electron microscope (TEM): JEOL 2010HR TEM, which provides a highly collimated electron beam and high level of vacuum (less than 10⁻⁵ Pa). The vdW heterostructure was supported by a supporting grid. The supporting grid was held by a beryllium double tilt sample holder that can be rotated about the x- and y-axes (the vdW heterostructure lies on the x-y plane). With the help of Kikuchi lines, θₜᵢₗ^{k} was determined to have an accuracy better than 0.5 degrees. The output X-ray spectra were measured by using a silicon drift energy-dispersive X-ray spectroscopy (EDS) detector that was calibrated with an accuracy of ±2.5 eV. In the photon energy range of interest (0.7 keV-1.6 keV), the energy resolution of the EDS detector was R≈97 eV. The observation angle and observation angle range of the EDS detector were θ_{obs}≈112.5° and Δθ_{obs}≈12° respectively. The solid angle of the EDS detector was about 0.034 sr. In the measurements, increasing θₜᵢₗⁿ tilted the sample towards the EDS detector, shown in FIG. 24A. The thickness of graphite and MoS₂ layers was about 150 nm and 30 nm, respectively, according to an example embodiment. The electron beam spot size was about 10 nm, the beam divergence was about 1 mrad, and the beam current was about 2.5 nA.

Enhanced Versatility of Table-Top X-Rays from Van Der Waals Structures, According to Example Embodiments

FIG. 18B shows the PCB spectrum when a 200 keV electron beam is incident on a WSe₂ single crystal. The X-ray photon energy is tuned from 1026 eV to 946 eV when the tilt angle of the WSe₂ single crystal is varied from θₜᵢₗ=0° to θₜᵢₗ=25°, where θₜᵢₗ is determined to an accuracy better than 0.5° in the experiments by using Kikuchi lines. Kikuchi lines are produced by Bragg reflections of inelastically scattered electrons in crystals, which provides an effective way to accurately measure crystal orientation. For hexagonal crystals such as WSe₂ and MoS₂, the overlap between the [001] zone-axis and the incident electron beam results in bright lines (Kikuchi lines) that are distributed evenly around a central point (right insert in FIG. 18B). Tilt angle tunability is helpful according to an example embodiment in scenarios where other tuning mechanisms are not as readily available: for instance, tuning via the electron energy typically requires readjustment of the accelerating voltage and realigning of the electron beam; whereas tuning via atomic composition requires the growth of a completely new material. A TEM image of the WSe₂ sample is shown in the left insert of FIG. 18B. In FIGS. 18C and 18D, an electron energy range of 120 keV to 160 keV is considered. FIG. 18C shows that the achievable output photon energy range is 75 eV when θₜᵢₗ=0° and only the electron energy is allowed to vary. In FIG. 18D, this range increases by over 100% to 186 eV when the electron energy and the vdW structure tilt angle are allowed to simultaneously vary according to an example embodiment.

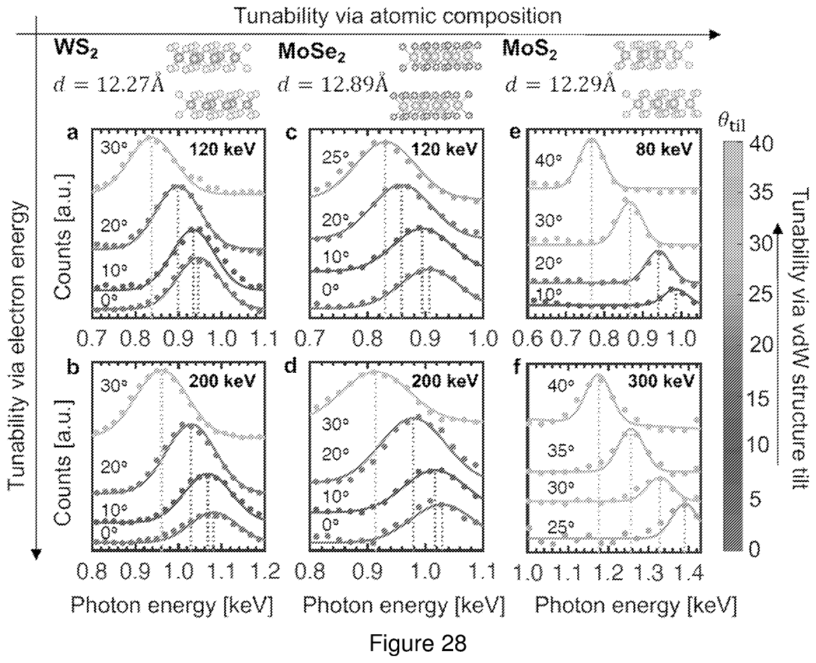

Dichalcogenide vdW materials like WSe₂, WS₂ and MoS₂ crystallize in a layered structure with slightly differing interlayer distances, which offer opportunities to tune the output X-ray photon energy via atomic composition according to an example embodiment. Combined with tunability via the vdW structure tilt and the electron energy, this makes vdW materials a versatile platform for compact X-ray generation according. FIG. 28 shows three-dimensional tunability of the vdW X-ray radiation according to example embodiments: tunability via the electron energy, tunability via the atomic composition, and tunability via the vdW structure tilt. Tunability via the atomic composition allows the pre-customization of a PCB X-ray source according to an example embodiment by choosing the constituents of the vdW structure. The many compound combinations possible in vdW materials advantageously provide precise control over the lattice constants that determine the radiation spectrum. On the other hand, tunability via the electron energy and via the vdW structure tilt provide dynamic tunability: the electron energy can be adjusted by changing the accelerator voltage of the electron source, and the vdW structure tilt angle can be adjusted by mechanical rotation. It should be noted that the intrinsic bandwidth of the PCB peaks is also very narrow, being on the order of 1 eV in the regime of study. The measured bandwidth is significantly broadened by the large energy resolutions and observation angle spreads of the respective EDS detectors. It should be noted that the demonstrated energy tunability (˜200 eV) greatly exceeds the intrinsic bandwidth of the X-ray source (˜1 eV). Furthermore, as will be described show below, a much larger range of X-ray photon energy tunability (>10 keV and more) can be achieved in different embodiments at observation angles and electrons energies beyond what was accessible in the electron microscope in the example embodiments described herein—but still on a table-top scale. The linewidth dependence of the X-ray peaks is as described by Equation (5). It should be noted that in the described experiments, the dominant contribution of the EDS detector's energy resolution and angular range eclipses the dependence of the X-ray peak linewidth on other factors such as electron energy and vdW tilt angle. A potential way to directly measure the narrow linewidth of the PCB peaks is by using Bragg's law-based techniques such as wavelength-dispersive X-ray spectroscopy (WDS), whose energy resolution can be on the order of 1 eV—instead of the EDS measurements described here.

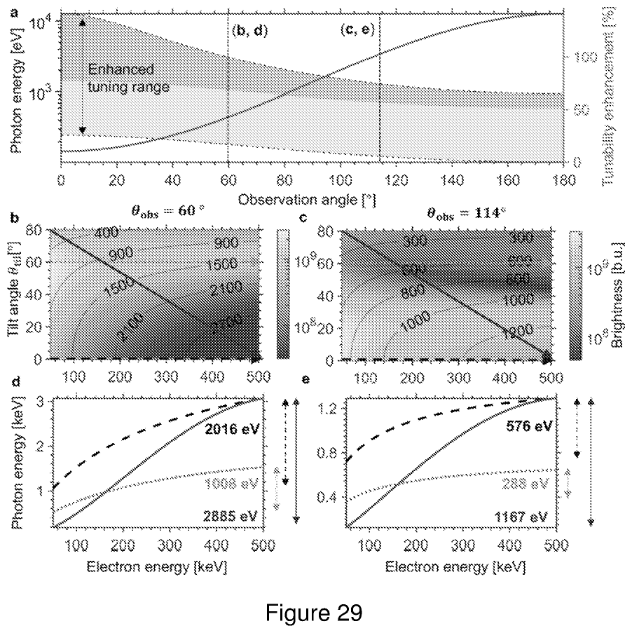

FIG. 29A depicts the X-ray photon energy range accessible with the vdW-based X-ray source according to an example embodiment. If only the electron energy is allowed to vary, only photon energies in the dark shaded region can be accessed. This region becomes increasingly narrow at larger observation angles, which favor softer X-rays that could be beneficial for biological imaging. On the other hand, if the electron energy is varied together with vdW structure tilt angle, we see that the accessible range of output X-ray photon energies expands to the entire dark and lighter shaded regions, bounded by the pair of dashed lines. The solid line in FIG. 29A reflects the percentage enhancement in accessible photon energy range by combining control over both electron energy and vdW structure tilt. This percentage enhancement is well in excess of 100% at larger detector angles. Here, an electron source that can be tuned from 50 keV to 500 keV is considered. FIGS. 29B, 29D and FIGS. 29C, 29E focus on the specific cases where θ_{obs}=60° and θ_{obs}=114° respectively. In both cases (as in all other cases used in FIG. 29A), the tuning scheme via electron energy and vdW structure tilt runs diagonally across the range of vdW structure tilt and electron energies considered (solid lines in FIGS. 29B, 29C). The resulting photon energy peaks are shown in FIGS. 29D, 29E respectively, and contrasted against cases where only the electron energy is allowed to vary (horizontal lines in FIGS. 29B, 29C). At the same time, the colormaps in FIGS. 29B, 29C show the brightness of the output X-ray photons, as calculated from equation (3). It is seen that the brightness can vary significantly across the entire tuning range. For any specific output X-ray photon energy, it is possible to maximize the X-ray brightness with the freedom to vary both electron energy and vdW structure tilt angle. Simultaneously controlling both electron energy and vdW structure tilt thus allows to optimize the accessible photon energy range as well as the intensity of the vdW X-ray source according to an example embodiment.

For relativistic electrons (1-10 MeV), tuning by varying the electron energy can become challenging at observation angles beyond 20°. One feasible way to tune the photon energy in real-time for relativistic electrons according to an example embodiment is via varying the vdW structure tilt angle. Specifically, tuning via varying the vdW structure tilt angle allows to enhance the emitted photon energy range by 1873% and 654% for θ_{obs}=1140 and θ_{obs}=60° respectively, compared to tuning by varying the electron energy.

The vdW X-ray generation scheme according to example embodiments is highly complementary to other existing methods of X-ray generation. Advantageously, the vdW X-ray source according to an example embodiment is dynamically tunable in frequency, unlike traditional X-ray tubes whose output peaks are fixed at the characteristic frequencies of the anode material. Furthermore, it requires neither highly relativistic electrons nor high intensity lasers, as in undulator-based X-ray sources and high-harmonic generation. The example embodiments described can provide for the realization of dynamically tunable, compact X-ray sources, which have a wide range of potential applications in imaging and inspection, including X-ray hyperspectral imaging and X-ray quantum optics. In particular, applications for narrowband X-rays already include X-ray diffraction and near-edge X-ray absorption fine structure (NEXAFS) measurements. The source according to an example embodiment has the potential to serve these applications, but with the added benefits of dynamic photon energy tunability and potentially higher brightness. In other example embodiments, shaping of incident free electrons—on the level of either the macroscopic bunch structure or the individual electron wavefunction—can lead to greater control and enhancement of the output radiation.

In the experiments described, 7.9×10⁴ PCB photons were measured over a duration of 1000 s (live time) from WS₂ at θₜᵢₗ=30°, shown in FIG. 28B. This yields a flux of 79 photons s⁻¹, which is in excellent agreement with the theory for a current of 0.34 nA. The relatively low electron current was used to avoid pileup effects during the measurement of X-rays by the EDS detector, whose dead time was kept below 30%. This scales to a brightness of ˜1×10⁹ photons s⁻¹ mm⁻² mrad⁻² per 0.1% BW when an electron beam of 1 nA current and 1 nm spot size is employed. This brightness also compares favorably with that of high harmonic generation (10⁶−10¹² photons s⁻¹ mm⁻² mrad⁻² per 0.1% BW) in the water-window. The angular flux density from an unoptimized source according to an example embodiment is about ˜1×10⁹ I (A) [photons s⁻¹ mrad⁻² per 0.1% BW], which already comes close to that of conventional X-ray tubes˜10⁷-10⁸ I (A) [photons s⁻¹ mrad⁻² per 0.1% BW], where I (A) refers to the current in Amperes. The thickness of the sample according to an example embodiment is about 100 nm, which corresponds to a few hundred atomic layers. The radiation intensity can be enhanced by increasing the sample thickness in different example embodiments, resulting in larger interaction length L. It should be noted that the peak brightness is directly proportional to the square of the interaction length (i.e., L²). Larger interaction lengths, however, come at the cost of broadened X-ray peaks due to deterioration in the quality of the electron beam as it travels through more of the material structure. The deterioration of the electron beam is in turn due to increased scattering events, which cause electrons to lose energy and/or be deflected from their original direction of travel. The X-ray peak brightness is also directly proportional to electron current. As in X-ray tubes, a larger electron current will generate more heat and increase the possibility of thermal damage. In this regard, van der Waals materials like graphite have an advantage over conventional materials (e.g., tungsten, commonly used as the anode in X-ray tubes) due to the former's superior thermal conductivity and melting point. Based on experimental results, it should be noted that just increasing the current to 1 mA—which is typical for X-ray tubes—already results in an X-ray photon flux in excess of 10⁸ photons/s according to an example embodiment, sufficient for X-imaging applications. Methods to increase the interaction length include having the electrons travel near the edge of vdW materials in a Smith-Purcell-like configuration that has been termed edge PXR This allows the electron's Coulomb fields to scatter off the crystal lattice while minimizing collisions of the electrons themselves with the material. In experiments, the measured PCB peak intensity is about 100 times larger than that of incoherent bremsstrahlung. Since the intensity of incoherent bremsstrahlung scales as ∝L, it is expected this ratio to increase when longer interaction distances are considered.

As described above, the versatility of the vdW-based free electron X-ray source can be significantly enhanced according to example embodiments, with the introduction of the vdW structure tilt angle as a control parameter, which can be varied in real-time by mechanically rotating the vdW target with respect to the electron beam. Specifically, the range of accessible photon energies increases by over 100% when one simultaneously varies both the electron energy and the vdW tilt angle. At the same time, a relativistic theory of PCB is presented that not only accounts for both PXR and CBS in the same framework, but also includes arbitrarily higher-order free electron radiation processes. This, combined with the ability to tailor the vdW-based X-rays via atomic composition, makes van der Waals materials a promising platform for highly versatile, tunable X-ray sources according to example embodiments. the results also show that a wide range of photon energies can be accessed just by varying the vdW tilt angle alone, even with a fixed electron energy and atomic composition in an example embodiment. Although the study focuses on moderate electron energies (0.05-10 MeV), the method of enhancing the photon energy range by combining control over electron energy and tilt angle according to an example embodiment applies to other ranges of electron energies, and also other crystalline material systems beyond vdW materials. The results pave the way to realizing compact sources of high-quality X-rays for applications including hyperspectral X-ray fluoroscopy and X-ray quantum optics.

The 2D bulk MX₂ (M=Mo, W; X=S, Se) single crystals were synthesized by the normal chemical vapor transport method. The stoichiometric ratio of high purity M and X with a bit of iodide as transport agent are loaded in a silica tube, which is sealed in a high vacuum environment. The sealed silica tube is loaded in a two-zone furnace, whose growth zone is heated to 850° C. and reaction zone is heated to 950° C. within 24 hours of time, and held for ten days. Finally, bulk MX₂ single crystals are collected in the growth zone. The few-layer MX₂ nanoflakes are exfoliated mechanically onto silicon substrates (covered with a 285 nm SiO₂ film), and transferred to Au supporting grids with the aid of the wet-transfer method.

The vdW-based X-ray emission measurements were conducted using an electron source with a highly collimated electron beam is sent towards the vdW material in the sample holder, which can be tilted. The emitted X-ray spectra were measured using a silicon drift energy dispersive X-ray spectroscopy (EDS) detector. The EDS detector was calibrated by ourselves to enable measurement of X-ray peak energies with an accuracy of 2.5 eV. The experiments shown in FIG. 18 and FIGS. 28A-D were conducted using an electron source of a JEOL 2010 HR TEM, which uses 120-200 keV electrons. In the photon energy range of 0.7 keV-1.4 keV, the energy resolution is R≈97 eV for the EDS detector. The detector's observation angle and observation angle range are θ_{obs}≈112.5° and Δθ_{obs}≈12° respectively. The experiments in FIGS. 28E-F were performed using an electron source of a JEM-ARM300F TEM, which uses 80 keV and 300 keV electrons. In the photon energy range of 0.7 keV-1.4 keV, energy resolution is R≈75 eV for the EDS detector. In both experimental set-ups, the sample holder is made of beryllium, and can be rotated about the x- and y-axes (the x-y plane being that which lies parallel to the surface of the sample holder), allowing to determine θₜᵢₗ to an accuracy better than 0.5 degrees with the help of Kikuchi lines. In all measurements, increasing θₜᵢₗ further tilts the sample towards the EDS detector. The range of θₜᵢₗ is ±30° and ±40° for the different electron sources from the JEOL 2010 HR TEM and the JEM-ARM300F TEM, respectively. In the measurements, the electron beam divergence is about 1 mrad, the spot size on the sample is about 10 nm, and the beam current is about 0.3 nA.

Quantum Recoil in Free Electron Interaction with Atomic Lattices According to Example Embodiments

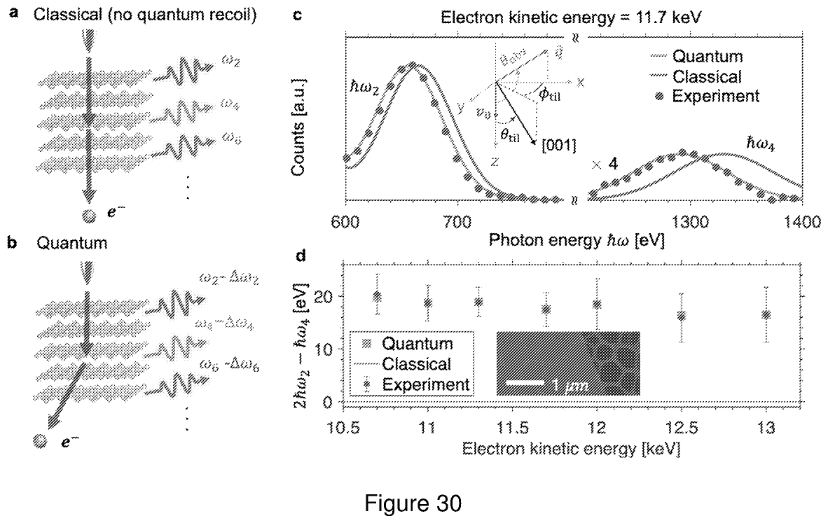

As described before, free electrons impinging on a crystalline solid (FIG. 30A) emit radiation via two mechanisms: the scattering of the Coulomb fields off the periodic lattice, commonly known as parametric X-ray radiation (PXR); and the acceleration of the electrons in the electrostatic potential, known as coherent bremsstrahlung. PXR, the dominant mechanism in our regime of study, is physically equivalent to the Smith-Purcell effect, with the periodic grating being supplied by the atomic lattice. In the classical picture (Maxwell's equations and the Newton-Lorentz equation) where quantum recoil is ignored, the momentum of the electron is assumed to be unchanged upon photon emission, and the output photon energy is given by

$${E}_{p}^{0} = - \frac{ℏ {g}_{z} {v}_{0}}{1 - {nv}_{0} cos ( {θ}_{o b s} ) / c} , \qquad ( 13 )$$

where ℏ is the reduced Planck constant, g_{z} is the z-component of grating vector g (whose magnitude is g), v₀ is the initial velocity of the incident electron (traveling in z), n is the refractive index of the medium, θ_{obs} is the polar angle of the photon emission direction, and c is the speed of light in free space.

Energy-momentum conservation, however, can lead to the outgoing electron possessing energy and momentum significantly different from that of the incoming electron (FIG. 30B). Accounting for this recoil, the output photon energy is obtained as

$${E}_{p} = - \frac{2 ℏ {g}_{z} {v}_{0} + {ℏ}^{2} {c}^{2} {g}^{2} / {E}_{i}}{1 - {nv}_{0} cos ( {θ}_{o b s} ) / c - n ℏ cg \cdot \hat{q} / {E}_{i}} \times {[ 1 + \sqrt{1 - \frac{{n}^{2} - 1}{{n}^{2}} \frac{{ℏ}^{2} {c}^{2} {g}^{2} + 2 ℏ {E}_{i} {g}_{z} {v}_{0}}{{[ {E}_{i} ( {v}_{0} cos {θ}_{o b s} / c - 1 / n + ℏ cg \cdot \hat{q} ]}^{2} )}} ]}^{- 1} , \qquad ( 14 )$$

where Eᵢ is the initial total energy (i.e., including rest mass) of the incident electron, \hat{q}=(sin θ_{obs} cos ϕ_{obs}, sin θ_{obs} sin ϕ_{obs}, cos θ_{obs}) is the unit vector of the emitted photon wave vector q, and ϕ_{obs} is the azimuthal angle of q. According to the Lorentz oscillator model, the refractive index in the X-ray range is given by n=1−ωₚ²/2ω²≈1, where ωₚ is the plasma frequency and ω is the angular frequency of the X-rays. We therefore simplify equation (14) to

$${E}_{p} \approx - \frac{ℏ {g}_{z} {v}_{0} + {ℏ}^{2} {c}^{2} {g}^{2} / 2 {E}_{i}}{1 - n {v}_{0} cos ( {θ}_{o b s} ) / c - n ℏ cg \cdot \hat{q} / {E}_{i}} , \qquad ( 15 )$$

When the terms proportional to ℏcg/2Eᵢ are negligible (i.e., the impact of quantum recoil is negligible), one recovers the classical equation (13) with n=1. In the experiment according example embodiments, an electron beam of kinetic energy around 10 keV interacts with 2D graphite oriented such that the electron travels at a small angle to the [001] direction. In this case, the grating vector g is given by

$${g}_{( 00 \overline{m} )} = - m \frac{2 π}{d} ( sin {θ}_{til} cos {ϕ}_{til} , sin {θ}_{til} , sin {ϕ}_{til} , cos {θ}_{til} ) \qquad ( 13 )$$

where m is an integer denoting the order of PXR, d is the interlayer distance of the (001) planes, and θₜᵢₗ and ϕₜᵢₗ respectively denote the polar and azimuthal angles of the [001] zone axis (see FIG. 30C). For hexagonal crystals such as graphite and hexagonal boron nitride, emission at odd m is forbidden. Therefore, the second-order (m=2) and fourth-order (m=4) PXR are measured according to an example embodiment. Taking into account the X-ray peak broadening due to the detector energy resolution, electron beam divergence, and the range of collection angles, the measured bandwidth (full width at half maximum) of the PXR peaks is obtained as

$$Δ {E}_{p} \approx \sqrt{{( \frac{5.6 ℏ {v}_{0}}{L} )}^{2} + {( \frac{\partial {E}_{p}}{\partial {θ}_{til}} Δ {θ}_{e} )}^{2} + {( \frac{\partial {E}_{p}}{\partial {θ}_{o b s}} Δ {θ}_{o b s} )}^{2} + {R}^{2} )} ,$$

where L is the interaction length, and Eₚ is the output photon energy (set to Eₚ⁰ for the nonrecoil case, i.e., equation (13)). The first term under the square root in equation (17) corresponds to the intrinsic bandwidth of the PXR peak, which is on the order of 1 eV in example embodiments. The second term corresponds to effects of electron beam divergence (Δθₑ≈10 mrad). The third term accounts for the finite range of observation directions (Δθ_{obs}≈11°) admitted by the angular aperture of the EDS detector. The final term accounts for the energy resolution of the energy dispersive X-ray spectroscopy (EDS) detector, where R≈62 eV (72 eV) for photon energies around 650 eV (1300 eV). FIG. 30C shows a multimode X-ray spectrum according to an example embodiment generated by an 11.7 keV electron beam impinging on a graphite single crystal. The filled circles are experimental results. The lines are theoretical results corresponding to the “classical” (equation (13)) and “quantum” (equation (15)) models, respectively, at observation angle θ_{obs}=130°, and vdW material tilt angles θₜᵢₗ=14° and ϕₜᵢₗ=0°. The interaction length L≈100 nm in the experiments. Using equations (13) and equation (15), respectively, in equation (17) yields the predicted bandwidths for the classical and quantum cases. The experimental results are in excellent agreement with quantum theory, and show noticeable discrepancies from the predictions of classical theory.

As another way of analyzing the photon energy shift induced by quantum recoil, the energy difference between the second-order (ℏω₂) and fourth-order (ℏω₄) emission peaks are considered. In the classical picture, equation (13) yields 2ℏω₂−ℏω₄≡0, independent of all parameters including θₜᵢₗ and electron energy. Equation (15), which includes the effects of quantum recoil, shows that the difference generally takes on a non-zero value that depends on the choice of experimental parameters. The experimental results (FIG. 30D) are indicated by the filled circles, with error bars determined by Gaussian fitting of the measured PXR peaks. The good agreement between the experimental results and the theoretical predictions of equation (15) confirms that quantum recoil-induced photon energy shifts are indeed measurable using table-top electron sources according to example embodiments, and results constitute an unprecedented measurement of quantum recoil-induced photon energy shifts in relatively low-energy electrons scattering off a periodic grating (furnished in this case by the multilayer 2D-material stack of graphite).

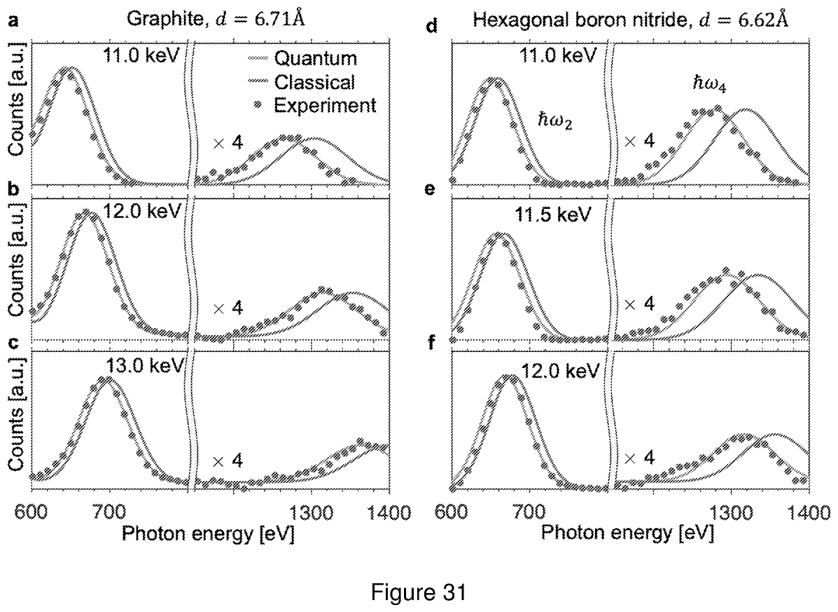

The measurements (compared against classical and quantum predictions) of various points in FIG. 30D are shown in FIGS. 31A-C. FIGS. 31D-F show results obtained under the same conditions as FIGS. 31A-C, but using hexagonal boron nitride instead of graphite. In all cases, one sees that the experimental measurements confirm the importance of taking quantum recoil into account when predicting the photon energy output from PXR. It should be noted that the PXR emission peaks are typically very narrowband (on the order of 1 eV). The large energy spread in FIGS. 30 and 31 is due to the energy resolution of the energy dispersive X-ray spectrometer (EDX) and the range of observation angles used in the experiments. As such, under the experimental conditions, the photon energy shifts as a function of quantum recoil are already very significant compared to the intrinsic photon energy bandwidth of the PXR process.

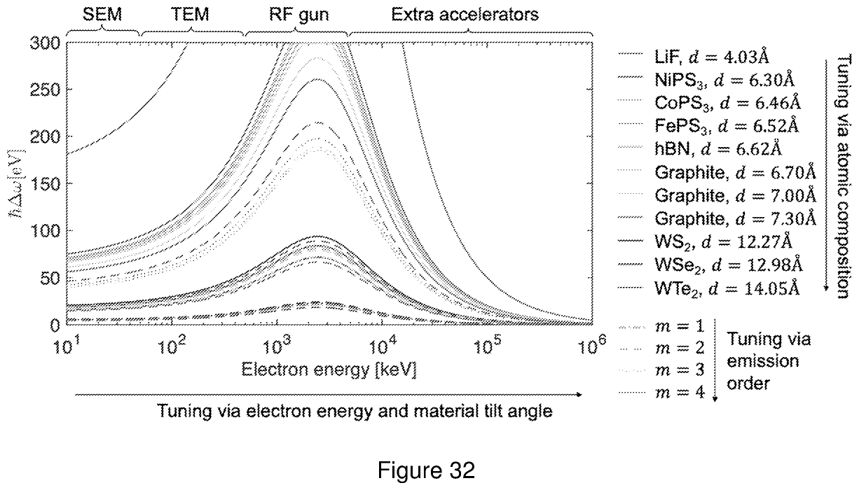

FIG. 32 illustrates the versatility of tuning the quantum recoil according to example embodiments—from practically zero recoil, to recoil so strong that a classical soft X-ray photon emerges as a low energy photon due to energy-momentum conservation. The tuning is accomplished, according to various example embodiments, either by varying the electron kinetic energy and material tilt angle; by changing the atomic composition of the target material; or by measuring radiation emission of different orders m, where m refers to radiation corresponding to the (00m̅) reciprocal lattice vector. Although FIG. 32 considers the specific case of a classically predicted 300 eV photon, the same principles and conclusions would apply to photons of other energies. Here, multiple values of d are used for graphite to reflect the fact that its interlayer spacing can be tuned by controlling the conditions of its synthesis, giving flexibility even with one type of material, according to an example embodiment. Importantly, the findings indicate that table-top electron sources of kinetic energies 1-300 keV (which includes electron sources used for table-top devices such as SEM and TEM), in combination with crystalline materials, are promising platforms according to example embodiments to investigate quantum recoil in free electron spontaneous emission.

Specifically, the quantum effects of electron-photon interactions can be measured and tuned in a lab-scale platform according to an example embodiment. This platform according to an example embodiment is useful for exploring new phenomena as well as realizing intriguing science in the regime of substantial quantum recoil. The findings directly corroborate effects arising in light-matter interaction due to quantization of the electromagnetic field. These effects were first analyzed in the context of Cherenkov radiation, and have been predicted to cause quantum recoil-induced photon energy shifts in free electron spontaneous emission. The findings according to example embodiments provide unprecedented experimental confirmation of these photon energy shifts in the context of PXR, which is fundamentally equivalent to the Smith-Purcell effect with atomic-scale gratings, in addition to being closely related to Cherenkov radiation. This shows that a table-top platform according to an example embodiment can already provide important headway into these studies. Together with higher-order QED processes and the quantum-wave nature of the electron (e.g., arising from shaping the electron wavefunction spatially and temporally), measuring quantum recoil according to an example embodiment paves the way to studying fundamental physics and potential technological advances arising from quantum aspects of electron-photon interactions.

The findings reveal that quantum recoil is significant and must be given due consideration even in the nonrelativistic limit, especially when nanoscale and sub-nanoscale periodicities are involved. This is important especially with increasing interest in nanoscale free electron-driven radiation sources, along with the use of low-energy electrons for chip-scale integration. The theory and experiments according to example embodiments focus on spontaneous emission resulting from free electron interaction with the nanometer and sub-nanometer gratings furnished by the periodic lattices of crystalline solids. This is highly complementary to existing analyses on free electron spontaneous emission using grating periods on the order of 10 nm and larger. The platform according to an example embodiment of the present invention naturally enjoys enormous versatility in quantum recoil tuning when one varies the accelerating voltage of the incident electrons, the tilt angle of the target material and/or the atomic composition of the target material.

It should be noted that any type of crystalline material—not just vdW materials—can serve as the target material in platforms according to various example embodiments. However, the advantage of using vdW materials arises from the large variety of compound combinations providing precise control over the lattice constants that affect the quantum recoil. The theory and experimental measurements according to example embodiments confirm the accuracy and importance of the Smith-Purcell formulation that includes quantum recoil (equation (15)), over the more popular version that assumes recoil is negligible (equation (13)). It is concluded that quantum recoil in PXR can be significant even when driven by “conventional” table-top electron sources used for table-top devices such as like SEMs and TEMs, which serve as robust, accessible platforms for investigations into quantum aspects of electron-photon interactions, according to example embodiments. Prospective applications also include the study of radiation reaction, where crystalline solids have been used for measurements in the regime of ultra-relativistic electron energies, and X-ray quantum optics.

Sample preparation for the experiments: The single-crystal hexagonal boron nitride was synthesized by the atmospheric pressure metal flux method. To measure the quantum recoil, the thickness of the sample is preferably on the order of 100s of nm with no substrate, so that the electrons can penetrate the sample without substantial deflection or scattering that contributes to background noise. The hexagonal boron nitride and graphite nanoflakes are exfoliated mechanically onto silicon substrates (with 285 nm SiO₂ film), and transferred to Au grids with the aid of the wet-transfer method. The Au grid is held by a support grid holder for scanning electron microscopes (SEM) during the X-ray measurements in SEM.

X-ray measurements in the experiments: The quantum recoil measurements were performed using an electron source of a SEM (EPMA) JEOL JXA-8530F. The emitted X-ray spectra were measured using a silicon drift energy dispersive X-ray spectroscopy (EDS) detector. The EDS detector was calibrated to measure the X-ray photon energies with an accuracy within ±0.5 eV by measuring the Kα peaks of C, N, O, F, Mg, Al and Si. The effect of refraction on the X-ray photon exiting the van der Waals crystal is taken into account. All experimental data in FIGS. 30 and 31 were obtained via measurements that took place over about four hours, and the corresponding X-ray count rate in each case was about 8,000 counts per second. The background radiation of the measured spectra was subtracted using NIST DTSA-II.

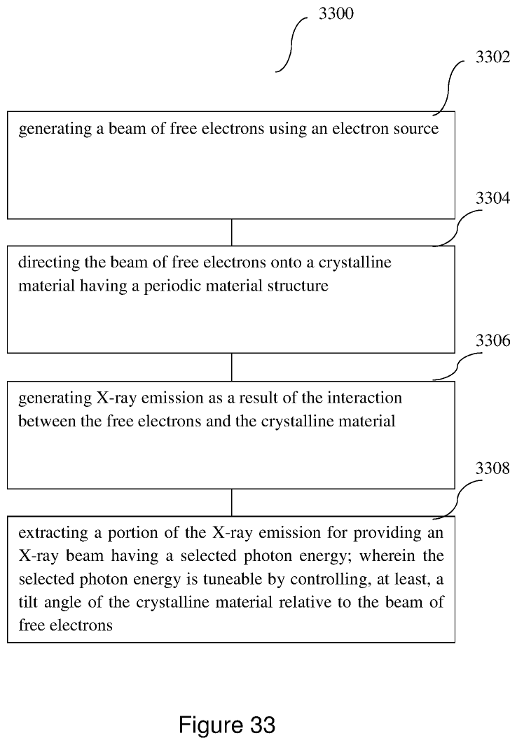

FIG. 33 shows a flowchart 3300 illustrating a method of generating X-ray emission, according to an example embodiment. At step 3302, a beam of free electrons is generated using an electron source. At step 3304, the beam of free electrons is directed onto a crystalline material having a periodic material structure. At step 3304, X-ray emission is generated as a result of the interaction between the free electrons and the crystalline material. At step 3306, a portion of the X-ray emission is extracted for providing an X-ray beam having a selected photon energy; wherein the selected photon energy is tunable by controlling, at least, a tilt angle of the crystalline material relative to the beam of free electrons.

The method may further comprise tuning the selected photon energy by controlling one or more of a group consisting of a collection angle for extracting the X-ray beam relative to the beam of free electrons, the crystalline material and its atomic composition, and an energy of the beam of free electrons. The method may comprise tuning the selected photon energy by simultaneously controlling at least two of a group consisting of the tilt angle of the crystalline material relative to the beam of free electrons, the collection angle for extracting the X-ray beam relative to the beam of free electrons, the crystalline material and its atomic composition, and the energy of the beam of free electrons.

The tilt angle may be controllable in a range from a channeling configuration in which the periodic structure extends substantially parallel to the beam of free electrons and a perpendicular configuration in which the period structure extends substantially perpendicular to the beam of free electrons.

The method may comprise directing the beam of free electrons onto a stack of two or more crystalline materials with different periodic structures and extracting two or more X-rays beams of different energy from respective ones of the two or more crystalline materials.

Extracting the X-ray beam may comprise disposing one or more windows having respective selected dimensions and collection angle at respective selected distances from the crystalline material such that only the X-ray beams passing through the respective one or more windows are extracted while a remaining portion of the generated X-ray emission is blocked. The method may further comprise controlling the dimensions of the respective one or more windows by changing apertures of the respective one or more windows.

The selected energy of the extracted X-ray beam or beams may be determined based on consideration of quantum recoil in the interaction between the free electrons and the crystalline material or materials. The selected energy of the extracted X-ray beam or beams may be determined based on:

$${E}_{p} = - \frac{2 ℏ {g}_{z} {v}_{0} + {ℏ}^{2} {c}^{2} {g}^{2} / {E}_{i}}{1 - {nv}_{0} cos ( {θ}_{o b s} ) / c - n ℏ cg \cdot \hat{q} / {E}_{i}} \times {[ 1 + \sqrt{1 - \frac{{n}^{2} - 1}{{n}^{2}} \frac{{ℏ}^{2} {c}^{2} {g}^{2} + 2 ℏ {E}_{i} {g}_{z} {v}_{0}}{{[ {E}_{i} ( {v}_{0} cos {θ}_{o b s} / c - 1 / n + ℏ cg \cdot \hat{q} ]}^{2} )}} ]}^{- 1} ,$$

where E₁ is the initial total energy (i.e., including rest mass) of the incident electron, \hat{q}=(sin θ_{obs} cos ϕ_{obs}, sin θ_{obs} sin ϕ_{obs}, cos θ_{obs}) is the unit vector of the emitted photon wave vector q, and ϕ_{obs} is the azimuthal angle of q.

In one embodiment, according to the Lorentz oscillator model, the refractive index in the X-ray range is given by n=1−ωₚ²/2ω²≈1, where ωₚ is the plasma frequency and ω is the angular frequency of the X-rays, and the selected energy of the extracted X-ray beam or beams is determined based on:

$${E}_{p} \approx - \frac{ℏ {g}_{z} {v}_{0} + {ℏ}^{2} {c}^{2} {g}^{2} / 2 {E}_{i}}{1 - n {v}_{0} cos ( {θ}_{o b s} ) / c - n ℏ cg \cdot \hat{q} / {E}_{i}} ,$$

In one embodiment a system for generating X-ray emission is provided, comprising:
an electron source disposed in a vacuum chamber for generating a beam of free electrons;
an electron optics disposed in the vacuum chamber for directing the beam of free electrons onto a crystalline material disposed in the vacuum chamber and having a periodic material structure, whereby X-ray emission is generated as a result of the interaction between the free electrons and the crystalline material; and
one or more windows in a wall structure of the vacuum chamber for extracting a portion of the X-ray emission for providing an X-ray beam having a selected photon energy, the one or more windows having respective selected dimensions and collection angles at respective selected distances from the crystalline material such that only the X-ray beams passing through the respective one or more windows are extracted while a remaining portion of the generated X-ray emission is blocked;
wherein the selected photon energy is tunable by controlling, at least, a tilt angle of the crystalline material relative to the beam of free electrons.

The selected photon energy may be further tunable by controlling one or more of a group consisting of a collection angle for extracting the X-ray beam relative to the beam of free electrons, the crystalline material and its atomic composition, and an energy of the beam of free electrons. The selected photon energy may be tunable by simultaneously controlling at least two of a group consisting of the tilt angle of the crystalline material relative to the beam of free electrons, the collection angle for extracting the X-ray beam relative to the beam of free electrons, the crystalline material and its atomic composition, and the energy of the beam of free electrons.

The tilt angle may be controllable in a range from a channeling configuration in which the periodic structure extends substantially parallel to the beam of free electrons and a perpendicular configuration in which the period structure extends substantially perpendicular to the beam of free electrons.

The system may comprise a stack of two or more crystalline materials with different periodic structures and wherein the windows in the wall structure of the vacuum chamber are disposed for extracting two or more X-rays beams of different energy from respective ones of the two or more crystalline materials as a result of the interaction between the free electrons and the two or more crystalline materials.

The dimensions of the respective one or more windows may be controllable by changing apertures of the respective one or more windows.

The selected energy of the extracted X-ray beam or beams may be determined based on consideration of quantum recoil in the interaction between the free electrons of the beam of free electrons and the crystalline material or materials. The selected energy of the extracted X-ray beam or beams may be determined based on:

$${E}_{p} = - \frac{2 ℏ {g}_{z} {v}_{0} + {ℏ}^{2} {c}^{2} {g}^{2} / {E}_{i}}{1 - {nv}_{0} cos ( {θ}_{o b s} ) / c - n ℏ cg \cdot \hat{q} / {E}_{i}} \times {[ 1 + \sqrt{1 - \frac{{n}^{2} - 1}{{n}^{2}} \frac{{ℏ}^{2} {c}^{2} {g}^{2} + 2 ℏ {E}_{i} {g}_{z} {v}_{0}}{{[ {E}_{i} ( {v}_{0} cos {θ}_{o b s} / c - 1 / n + ℏ cg \cdot \hat{q} ]}^{2} )}} ]}^{- 1} ,$$

where Eᵢ is the initial total energy (i.e., including rest mass) of the incident electron, \hat{q}=(sin θ_{obs} cos ϕ_{obs}, sin θ_{obs} sin ϕ_{obs}, cos θ_{obs}) is the unit vector of the emitted photon wave vector q, and ϕ_{obs} is the azimuthal angle of q.

In one embodiment, according to the Lorentz oscillator model, the refractive index in the X-ray range is given by n=1−ωₚ²/2ω²≈1, where ωₚ is the plasma frequency and ω is the angular frequency of the X-rays, and the selected energy of the extracted X-ray beam or beams is determined based on:

$${E}_{p} \approx - \frac{ℏ {g}_{z} {v}_{0} + {ℏ}^{2} {c}^{2} {g}^{2} / 2 {E}_{i}}{1 - n {v}_{0} cos ( {θ}_{o b s} ) / c - n ℏ cg \cdot \hat{q} / {E}_{i}} ,$$

### Commercial Applications of Example Embodiments

Embodiments of the present invention have many potential commercial applications such as in industrial radiography to detect tiny cracks and breaks in products, in medicine to diagnose broken bones and daily life to inspect baggage in airports, train stations, and other important places. Additionally, it has potential applications in hyper-spectrum X-ray fluoroscopy, X-ray quantum imaging, and single X-ray photon generation.

Aspects of the systems and methods described herein, such as the control of the electron kinetic energy, periodic structure tilt angle, periodic structure design, and X-ray window rotation/distance, may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course, the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

The various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. When received into any of a variety of circuitry (e.g. a computer), such data and/or instruction may be processed by a processing entity (e.g., one or more processors).

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features described for different embodiments, including in the summary section, even if the feature or combination of features is not explicitly specified in the claims or the detailed description of the present embodiments.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

1. A method of generating X-ray emission, comprising the steps of:
generating a beam of free electrons using an electron source;
directing the beam of free electrons onto a crystalline material having a periodic material structure;
generating X-ray emission as a result of the interaction between the free electrons and the crystalline material; and
extracting a portion of the X-ray emission for providing an X-ray beam having a selected photon energy;
wherein the selected photon energy is tunable by controlling, at least, a tilt angle of the crystalline material relative to the beam of free electrons.

2. The method of claim 1, further comprising tuning the selected photon energy by controlling one or more of a group consisting of a collection angle for extracting the X-ray beam relative to the beam of free electrons, the crystalline material and its atomic composition, and an energy of the beam of free electrons.

3. The method of claim 2, comprising tuning the selected photon energy by simultaneously controlling at least two of a group consisting of the tilt angle of the crystalline material relative to the beam of free electrons, the collection angle for extracting the X-ray beam relative to the beam of free electrons, the crystalline material and its atomic composition, and the energy of the beam of free electrons.

4. The method of claim 1, wherein the tilt angle is controllable in a range from a channeling configuration in which the periodic structure extends substantially parallel to the beam of free electrons and a perpendicular configuration in which the periodic structure extends substantially perpendicular to the beam of free electrons.

5. The method of claim 1, comprising directing the beam of free electrons onto a stack of two or more crystalline materials with different periodic structures and extracting two or more X-rays beams of different energy from respective ones of the two or more crystalline materials.

6. The method of claim 1, wherein extracting the X-ray beam comprises disposing one or more windows having respective selected dimensions and collection angle at respective selected distances from the crystalline material such that only the X-ray beams passing through the respective one or more windows are extracted while a remaining portion of the generated X-ray emission is blocked.

7. The method of claim 6, further comprising controlling the dimensions of the respective one or more windows by changing apertures of the respective one or more windows.

8. The method of claim 1, wherein the selected energy of the extracted X-ray beam or beams is determined based on consideration of quantum recoil in the interaction between the free electrons and the crystalline material or materials.

9. The method of claim 8, wherein the selected energy of the extracted X-ray beam or beams is determined based on:
$${E}_{p} = - \frac{2 ℏ {g}_{z} {v}_{0} + {ℏ}^{2} {c}^{2} {g}^{2} / {E}_{i}}{1 - {nv}_{0} cos ( {θ}_{o b s} ) / c - n ℏ cg \cdot \hat{q} / {E}_{i}} \times {[ 1 + \sqrt{1 - \frac{{n}^{2} - 1}{{n}^{2}} \frac{{ℏ}^{2} {c}^{2} {g}^{2} + 2 ℏ {E}_{i} {g}_{z} {v}_{0}}{{[ {E}_{i} ( {v}_{0} cos {θ}_{o b s} / c - 1 / n + ℏ cg \cdot \hat{q} ]}^{2} )}} ]}^{- 1} ,$$
where Eᵢ is the initial total energy including rest mass of the incident electron, \hat{q}=(sin θ_{obs} cos ϕ_{obs}, sin θ_{obs} sin ϕ_{obs}, cos θ_{obs}) is the unit vector of the emitted photon wave vector q, and ϕ_{obs} is the azimuthal angle of q.

10. The method of claim 9, wherein, according to the Lorentz oscillator model, the refractive index in the X-ray range is given by n=1−ωₚ²/2ω²≈1, where ωₚ is the plasma frequency and ω is the angular frequency of the X-rays, and the selected energy of the extracted X-ray beam or beams is determined based on:
$${E}_{p} \approx - \frac{ℏ {g}_{z} {v}_{0} + {ℏ}^{2} {c}^{2} {g}^{2} / 2 {E}_{i}}{1 - n {v}_{0} cos ( {θ}_{o b s} ) / c - n ℏ cg \cdot \hat{q} / {E}_{i}} ,$$

11. A system for generating X-ray emission, comprising:
an electron source disposed in a vacuum chamber for generating a beam of free electrons;
an electron optics disposed in the vacuum chamber for directing the beam of free electrons onto a crystalline material disposed in the vacuum chamber and having a periodic material structure, whereby X-ray emission is generated as a result of the interaction between the free electrons and the crystalline material; and
one or more windows in a wall structure of the vacuum chamber for extracting a portion of the X-ray emission for providing an X-ray beam having a selected photon energy, the one or more windows having respective selected dimensions and collection angles at respective selected distances from the crystalline material such that only the X-ray beams passing through the respective one or more windows are extracted while a remaining portion of the generated X-ray emission is blocked;
wherein the selected photon energy is tunable by controlling, at least, a tilt angle of the crystalline material relative to the beam of free electrons.

12. The system of claim 11, wherein the selected photon energy is further tunable by controlling one or more of a group consisting of a collection angle for extracting the X-ray beam relative to the beam of free electrons, the crystalline material and its atomic composition, and an energy of the beam of free electrons.

13. The system of claim 12, wherein the selected photon energy is tunable by simultaneously controlling at least two of a group consisting of the tilt angle of the crystalline material relative to the beam of free electrons, the collection angle for extracting the X-ray beam relative to the beam of free electrons, the crystalline material and its atomic composition, and the energy of the beam of free electrons.

14. The system of claim 11, wherein the tilt angle is controllable in a range from a channeling configuration in which the periodic structure extends substantially parallel to the beam of free electrons and a perpendicular configuration in which the period structure extends substantially perpendicular to the beam of free electrons.

15. The system of claim 11, comprising a stack of two or more crystalline materials with different periodic structures and wherein the windows in the wall structure of the vacuum chamber are disposed for extracting two or more X-rays beams of different energy from respective ones of the two or more crystalline materials as a result of the interaction between the free electrons and the two or more crystalline materials.

16. The system of claim 11, wherein the dimensions of the respective one or more windows are controllable by changing apertures of the respective one or more windows.

17. The system of claim 11, wherein the selected energy of the extracted X-ray beam or beams is determined based on consideration of quantum recoil in the interaction between the free electrons and the crystalline material or materials.

18. The system of claim 17, wherein the selected energy of the extracted X-ray beam or beams is determined based on:
$${E}_{p} = - \frac{2 ℏ {g}_{z} {v}_{0} + {ℏ}^{2} {c}^{2} {g}^{2} / {E}_{i}}{1 - {nv}_{0} cos ( {θ}_{o b s} ) / c - n ℏ cg \cdot \hat{q} / {E}_{i}} \times {[ 1 + \sqrt{1 - \frac{{n}^{2} - 1}{{n}^{2}} \frac{{ℏ}^{2} {c}^{2} {g}^{2} + 2 ℏ {E}_{i} {g}_{z} {v}_{0}}{{[ {E}_{i} ( {v}_{0} cos {θ}_{o b s} / c - 1 / n + ℏ cg \cdot \hat{q} ]}^{2} )}} ]}^{- 1} ,$$
where Eᵢ is the initial total energy including rest mass of the incident electron, \hat{q}=(sin θ_{obs} cos ϕ_{obs}, sin θ_{obs} sin ϕ_{obs}, cos θ_{obs}) is the unit vector of the emitted photon wave vector q, and ϕ_{obs} is the azimuthal angle of q.

19. The system of claim 18, wherein, according to the Lorentz oscillator model, the refractive index in the X-ray range is given by n=1−ωₚ²/2ω²≈1, where ωₚ is the plasma frequency and ω is the angular frequency of the X-rays, and the selected energy of the extracted X-ray beam or beams is determined based on:
$${E}_{p} \approx - \frac{ℏ {g}_{z} {v}_{0} + {ℏ}^{2} {c}^{2} {g}^{2} / 2 {E}_{i}}{1 - n {v}_{0} cos ( {θ}_{o b s} ) / c - n ℏ cg \cdot \hat{q} / {E}_{i}} ,$$
